(19) United States
(12) Patent Application Publication
(10) Pub. No.: US 2023/0074583 A1
(43) Pub. Date: Mar. 9, 2023

(54) LOW-COLOR POLYMERS FOR USE IN ELECTRONIC DEVICES

(71) Applicant: DUPONT ELECTRONICS, INC., Wilmington, DE (US)

(72) Inventors: Brian C. Auman, Avondale, PA (US); John Donald Summers, Hapel Hill, NC (US); Nora Sabina Radu, Landenburg, PA (US); Chai Kit Ngai, Chadds ford, PA (US); Wayne Atkinson, New Castle (DE); Wei Li, Middletown, DE (US); Jonathan Timothy Maeyer, Haddonfield, NJ (US)

(21) Appl. No.: 17/982,217

(22) Filed: Nov. 7, 2022

Related U.S. Application Data
(63) Continuation of application No. 16/648,183, filed on Mar. 17, 2020.
(60) Provisional application No. 62/560,274, filed on Sep. 19, 2017.

(51) Int. Cl. C08G 73/10; C08J 5/18; G02B 1/04; G02F 1/1333

(52) U.S. Cl. CPC C08G 73/1042; C08G 73/1039; C08G 73/1067; C08J 5/18; G02B 1/04; G02F 1/133305; C08J 2379/08

(57) ABSTRACT

Disclosed is a polyimide film that exhibits: an in-plane coefficient of thermal expansion (CTE) that is less than 75 ppm/° C. between 50° C. and 250° C.; a glass transition temperature (T_{g}) that is greater than 250° C. for the polyimide film cured at 260° C. in air; a 1% TGA weight loss temperature that is greater than 450° C.; a tensile modulus that is between 1.5 GPa and 5.0 GPa; an elongation to break that is greater than 20%; an optical retardation at 550 nm that is less than 100 nm for a 10-μm film; a birefringence at 633 nm that is less than 0.002; a haze that is less than 1.0%; a b* that is less than 3; a yellowness index that is less than 5; and an average transmittance between 380 nm and 780 nm that is greater than 88%.

### CLAIM OF BENEFIT OF PRIOR APPLICATION

This application is a continuation of prior application Ser. No. 16/648,183 filed Sep. 11, 2018 which claims the benefit of U.S. Provisional Application No. 62/560,274, filed Sep. 19, 2017, which is incorporated in its entirety herein by reference.

### BACKGROUND INFORMATION

### Field of the Disclosure

The present disclosure relates to novel polymeric compounds. The disclosure further relates to methods for preparing such polymeric compounds and electronic devices having at least one layer comprising these materials.

### Description of the Related Art

Materials for use in electronics applications often have strict requirements in terms of their structural, optical, thermal, electronic, and other properties. As the number of commercial electronics applications continues to increase, the breadth and specificity of requisite properties demand the innovation of materials with new and/or improved properties. Polyimides represent a class of polymeric compounds that has been widely used in a variety of electronics applications. They can serve as a flexible replacement for glass in electronic display devices provided that they have suitable properties. These materials can function as a component of Liquid Crystal Displays (“LCDs”), where their modest consumption of electrical power, light weight, and layer flatness are critical properties for effective utility. Other uses in electronic display devices that place such parameters at a premium include device substrates, substrates for color filter sheets, cover films, touch screen panels, and others.

A number of these components are also important in the construction and operation of organic electronic devices having an organic light emitting diode (“OLED”). OLEDs are promising for many display applications because of their high power conversion efficiency and applicability to a wide range of end-uses. They are increasingly being used in cell phones, tablet devices, handheld/laptop computers, and other commercial products. These applications call for displays with high information content, full color, and fast video rate response time in addition to low power consumption.

Polyimide films generally possess sufficient thermal stability, high glass transition temperature, and mechanical toughness to merit consideration for such uses. Also, polyimides generally do not develop haze when subject to repeated flexing, so they are often preferred over other transparent substrates like polyethylene terephthalate (PET) and polyethylene naphthalate (PEN) in flexible display applications.

The traditional amber color of polyimides, however, precludes their use in some display applications such as color filters and touch screen panels since a premium is placed on optical transparency. Further, polyimides are generally stiff, highly aromatic materials; and the polymer chains tend to orient in the plane of the film/coating as the film/coating is being formed. This leads to differences in refractive index in the parallel vs. perpendicular directions of the film (birefringence) which produces optical retardation that can negatively impact display performance. If polyimides are to find additional applications in the displays market, a solution is needed to maintain their desirable properties, while at the same time improving their optical transparency and reducing the amber color and birefringence that leads to optical retardation.

A number of materials-development strategies have been invoked towards these goals. Although synthetic strategies that disrupt relatively-rigid polymer chain conformation with monomers containing flexible bridging units and/or meta linkages have shown some promise; the polyimides that result from such syntheses may exhibit an increased coefficient of thermal expansion (CTE), lower glass transition temperature (T_{g}), and/or lower modulus than is desirable in many end-use applications. The same property drawbacks often follow from synthetic strategies that are intended to disrupt polymer chain conformation via the introduction of monomers with bulky side groups.

A number of other strategies have been similarly unsuccessful in the preparation of polyimide films that exhibit low color. The use of aliphatic or partially-aliphatic monomers, while effective in disrupting the long-range conjugation that can lead to excessive color, has been found to lead to polyimides with reduced mechanical and thermal performance for many electronics end-uses. The use of dianhydrides with low electron affinity and/or diamines that are weak electron donors has also been attempted. Such structural modifications, however, can yield unacceptably-slow polymerization rates for use in industrial applications.

Finally; the use of very high purity monomers, particularly the diamine component of polyimides, has been attempted as a mechanism to reduce the color characteristics of these films. Industrial processing associated with this approach to low-color materials, however, is generally cost-prohibitive in current commercial electronics applications.

There is thus a continuing need for low-color materials that are suitable for use in electronic devices.

### SUMMARY

There is provided a solution containing a polyamic acid in a high-boiling, aprotic solvent; wherein the polyamic acid comprises one or more tetracarboxylic acid components and one or more diamine components; and wherein at least one of the tetracarboxylic acid components is a quadrivalent organic group derived from a bent dianhydride or an aromatic dianhydride comprising —O—, —CO—, —NHCO—, —S—, —SO₂—, —CO—O—, or —CR₂— links, or a direct chemical bond between aromatic rings; and wherein at least one of the diamine components is a divalent organic group derived from a bent diamine or an aromatic diamine comprising —O—, —CO—, —NHCO—, —S—, —SO₂—, —CO—O—, or —CR₂— links, or a direct chemical bond between aromatic rings; and wherein

R is the same or different at each occurrence and is selected from the group consisting of H, F, alkyl, and fluoroalkyl.

There is further provided a polyimide film generated from a solution containing a polyamic acid in a high-boiling, aprotic solvent; wherein the polyamic acid comprises one or more tetracarboxylic acid components and one or more diamine components; and wherein at least one of the tetracarboxylic acid components is a quadrivalent organic group derived from a bent dianhydride or an aromatic dianhydride comprising —O—, —CO—, —NHCO—, —S—, —SO₂—, —CO—O—, or —CR₂— links, or a direct chemical bond between aromatic rings; and wherein at least one of the diamine components is a divalent organic group derived from a bent diamine or an aromatic diamine comprising —O—, —CO—, —NHCO—, —S—, —SO₂—, —CO—O—, or —CR₂ links, or a direct chemical bond between aromatic rings; and wherein

R is the same or different at each occurrence and is selected from the group consisting of H, F, alkyl, and fluoroalkyl.

There is further provided a polyimide film comprising the repeat unit of Formula I

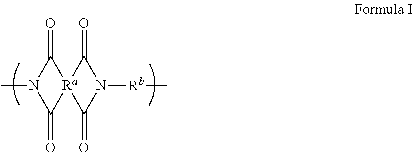

wherein:
R^{a} is a quadrivalent organic group derived from one or more acid dianhydrides selected from the group consisting of bent dianhydrides and aromatic dianhydrides containing one or more aromatic tetracarboxylic acid components comprising —O—, —CO—, —NHCO—, —S—, —SO₂—, —CO—O—, or —CR₂— chains, or a direct chemical bond between aromatic rings;
   and
R^{b} is a divalent organic group derived from one or more diamines selected from the group consisting of bent diamines and aromatic diamines comprising —O—, —CO—, —NHCO—, —S—, —SO₂—, —CO—O—, or —CR₂— chains, or a direct chemical bond between aromatic rings;
   wherein:

R is the same or different at each occurrence and is selected from the group consisting of H, F, alkyl, and fluoroalkyl; such that:
the in-plane coefficient of thermal expansion (CTE) is less than 75 ppm/° C. between 50° C. and 250° C.;
the glass transition temperature (T_{g}) is greater than 250° C. for a polyimide film cured at 260° C. in air;
the 1% TGA weight loss temperature is greater than 450° C.;
the tensile modulus is between 1.5 GPa and 5.0 GPa;
the elongation to break is greater than 20%;
the optical retardation at 550 nm is less than 20 nm for a 10-μm film;
the birefringence at 633 nm is less than 0.002;
the haze is less than 1.0%;
the b* is less than 3;
the yellowness index is less than 5; and
the average transmittance between 380 nm and 780 nm is greater than 88%.

There is further provided a method for preparing a polyimide film, said method selected from the group consisting of a thermal method and a modified-thermal method, wherein the thermal method comprises the following steps in order
coating one or more of the polyamic acid solutions disclosed herein onto a matrix;
soft-baking the coated matrix;
treating the soft-baked, coated matrix at a plurality of pre-selected temperatures for a plurality of pre-selected time intervals;
   whereby the polyimide film exhibits:
an in-plane coefficient of thermal expansion (CTE) that is less than 75 ppm/° C. between 50° C. and 250° C.;
a glass transition temperature (T_{g}) that is greater than 250° C. for a polyimide film cured at 260° C. in air or N₂;
a 1% TGA weight loss temperature that is greater than 450° C.;
a tensile modulus that is between 1.5 GPa and 5.0 GPa;
an elongation to break that is greater than 20%;
an optical retardation at 550 nm that is less than 20 nm for a 10-μm film;
a birefringence at 633 nm that is less than 0.002;
a haze that is less than 1.0%;
a b* that is less than 3;
a yellowness index that is less than 5; and
an average transmittance between 380 nm and 780 nm that is greater than 88%.

There is further provided a flexible replacement for glass in an electronic device wherein the flexible replacement for glass is a polyimide film having the repeat unit of Formula I

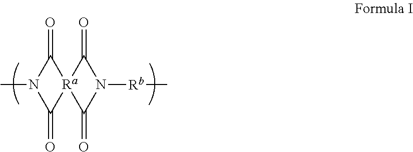

wherein:
Rₐ is a quadrivalent organic group derived from one or more acid dianhydrides selected from the group consisting of bent dianhydrides and aromatic dianhydrides containing one or more aromatic tetracarboxylic acid components comprising —O—, —CO—, —NHCO—, —S—, —SO₂—, —CO—C—, or —CR₂— chains, or a direct chemical bond between aromatic rings;
   and
R^{b} is a divalent organic group derived from one or more diamines selected from the group consisting of bent diamines and aromatic diamines comprising —O—, —CO—, —NHCO—, —S—, —SO₂—, —CO—O—, or —CR₂— chains, or a direct chemical bond between aromatic rings;
   wherein:

R is the same or different at each occurrence and is selected from the group consisting of H, F, alkyl, and fluoroalkyl.

There is further provided an organic electronic device, such as an OLED, wherein the organic electronic device contains a flexible replacement for glass as disclosed herein.

The foregoing general description and the following detailed description are exemplary and explanatory only and are not restrictive of the invention, as defined in the appended claims.

### BRIEF DESCRIPTION OF THE DRAWINGS

Embodiments are illustrated in the accompanying figures to improve understanding of concepts as presented herein.

FIG. 1 includes an illustration of one example of a polyimide film that can act as a flexible replacement for glass.

FIG. 2 includes an illustration of one example of an electronic device that includes a flexible replacement for glass.

Skilled artisans appreciate that objects in the figures are illustrated for simplicity and clarity and have not necessarily been drawn to scale. For example, the dimensions of some of the objects in the figures may be exaggerated relative to other objects to help to improve understanding of embodiments.

### DETAILED DESCRIPTION

There is provided a solution containing a polyamic acid in a high-boiling, aprotic solvent; wherein the polyamic acid comprises one or more tetracarboxylic acid components and one or more diamine components; and wherein at least one of the tetracarboxylic acid components is a quadrivalent organic group derived from a bent dianhydride or an aromatic dianhydride comprising —O—, —CO—, —NHCO—, —S—, —SO₂—, —CO—C—, or —CR₂-links, or a direct chemical bond between aromatic rings; and wherein at least one of the diamine components is a divalent organic group derived from a bent diamine or an aromatic diamine comprising —C—, —CO—, —NHCO—, —S—, —SO₂—, —CO—C—, or —CR₂— links, or a direct chemical bond between aromatic rings; and wherein R is the same or different at each occurrence and is selected from the group consisting of H, F, alkyl, and fluoroalkyl; as described in detail below.

There is further provided one or more polyimide films whose repeat units have the structure in Formula I.

There is further provided one or more methods for preparing a polyimide film wherein the polyimide film has the repeat unit of Formula I.

There is further provided a flexible replacement for glass in an electronic device wherein the flexible replacement for glass is a polyimide film having the repeat unit of Formula I.

There is further provided an electronic device having at least one layer comprising a polyimide film having the repeat unit of Formula I.

Many aspects and embodiments have been described above and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims. The detailed description first addresses Definitions and Clarification of Terms followed by the Polyimide Films Having the Repeat Unit Structure in Formula I, the Methods for Preparing the Polyimide Films, the Flexible Replacement for Glass in an Electronic Device, the Electronic Device, and finally Examples.

### 1. Definitions and Clarification of Terms

Before addressing details of embodiments described below, some terms are defined or clarified.

As used in the “Definitions and Clarification of Terms”, R, R^{a}, R^{b}, R′, R″ and any other variables are generic designations and may be the same as or different from those defined in the formulas.

The term “alignment layer” is intended to mean a layer of organic polymer in a liquid-crystal device (LCD) that aligns the molecules closest to each plate as a result of its being rubbed onto the LCD glass in one preferential direction during the LCD manufacturing process.

As used herein, the term “alkyl” includes branched and straight-chain saturated aliphatic hydrocarbon groups. Unless otherwise indicated, the term is also intended to include cyclic groups. Examples of alkyl groups include methyl, ethyl, propyl, isopropyl, isobutyl, secbutyl, tertbutyl, pentyl, isopentyl, neopentyl, cyclopentyl, hexyl, cyclohexyl, isohexyl and the like. The term “alkyl” further includes both substituted and unsubstituted hydrocarbon groups. In some embodiments, the alkyl group may be mono-, di- and tri-substituted. One example of a substituted alkyl group is trifluoromethyl. Other substituted alkyl groups are formed from one or more of the substituents described herein. In certain embodiments alkyl groups have 1 to 20 carbon atoms. In other embodiments, the group has 1 to 6 carbon atoms. The term is intended to include heteroalkyl groups. Heteroalkyl groups may have from 1-20 carbon atoms.

The term “aprotic” refers to a class of solvents that lack an acidic hydrogen atom and are therefore incapable of acting as hydrogen donors. Common aprotic solvents include alkanes, carbon tetrachloride (CCl₄), benzene, dimethyl formamide (DMF), N-methyl-2-Pyrrolidone (NMP), dimethylacetamide (DMAc), and many others.

The term “aromatic compound” is intended to mean an organic compound comprising at least one unsaturated cyclic group having 4n+2 delocalized pi electrons. The term is intended to encompass both aromatic compounds having only carbon and hydrogen atoms, and heteroaromatic compounds wherein one or more of the carbon atoms within the cyclic group has been replaced by another atom, such as nitrogen, oxygen, sulfur, or the like.

The term “aryl” or “aryl group” means a moiety derived from an aromatic compound. A group “derived from” a compound, indicates the radical formed by removal of one or more hydrogen (“H”) or deuterium (“D”). The aryl group may be a single ring (monocyclic) or have multiple rings (bicyclic, or more) fused together or linked covalently. A “hydrocarbon aryl” has only carbon atoms in the aromatic ring(s). A “heteroaryl” has one or more heteroatoms in at least one aromatic ring. In some embodiments, hydrocarbon aryl groups have 6 to 60 ring carbon atoms; in some embodiments, 6 to 30 ring carbon atoms. In some embodiments, heteroaryl groups have from 4-50 ring carbon atoms; in some embodiments, 4-30 ring carbon atoms.

The term “alkoxy” is intended to mean the group —OR, where R is alkyl.

The term “aryloxy” is intended to mean the group —OR, where R is aryl.

Unless otherwise indicated, all groups can be substituted or unsubstituted. An optionally substituted group, such as, but not limited to, alkyl or aryl, may be substituted with one or more substituents which may be the same or different. Suitable substituents include D, alkyl, aryl, nitro, cyano, —N(R′)(R′), halo, hydroxy, carboxy, alkenyl, alkynyl, cycloalkyl, heteroaryl, alkoxy, aryloxy, heteroaryloxy, alkoxycarbonyl, perfluoroalkyl, perfluoroalkoxy, arylalkyl, silyl, siloxy, siloxane, thioalkoxy, —S(O)₂—, —C(═O)—N(R′)(R″), (R′)(R″)N-alkyl, (R′)(R″)N-alkoxyalkyl, (R′)(R″)N-alkylaryloxyalkyl, —S(O)s-aryl (where s=0-2) or —S(O)s-heteroaryl (where s=0-2). Each R′ and R″ is independently an optionally substituted alkyl, cycloalkyl, or aryl group. R′ and R″, together with the nitrogen atom to which they are bound, can form a ring system in certain embodiments. Substituents may also be crosslinking groups. Any of the preceding groups with available hydrogens may also be deuterated.

The term “amine” is intended to mean a compound or functional group that contains a basic nitrogen atom with a lone pair. It refers to the group —NH₂ or —NR₂, where R is the same or different at each occurrence and can be an alkyl group, an aryl group, or deuterated analogs thereof. The term “diamine” is intended to mean a compound or functional group that contains two basic nitrogen atoms with associated lone pairs. The term “bent diamine” is intended to mean a diamine wherein the two basic nitrogen atoms and associated lone pairs are asymmetrically disposed about the center of symmetry of the corresponding compound or functional group, e.g. m-phenylenediamine:

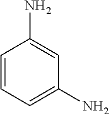

The term “aromatic diamine component” is intended to mean the divalent moiety bonded to the two amino groups in an aromatic diamine compound. The aromatic diamine component is derived from an aromatic diamine compound. The aromatic diamine component may also be described as being made from an aromatic diamine compound.

The term “b*” is intended to mean the b* axis in the CIELab Color Space that represents the yellow/blue opponent colors. Yellow is represented by positive b* values, and blue is represented by negative b* values. Measured b* values may be affected by solvent, particularly since solvent choice may affect color measured on materials exposed to high-temperature processing conditions. This may arise as the result of inherent properties of the solvent and/or properties associated with low levels of impurities contained in various solvents. Particular solvents are often preselected to achieve desired b* values for a particular application.

The term “bent” is intended to mean the molecular geometry associated with non-collinear distribution of atoms or groups of atoms about a center of symmetry. Such geometries can arise, for example, because of the presence of electron lone pairs or steric influences.

The term “birefringence” is intended to mean the difference in the refractive index in different directions in a polymer film or coating. This term usually refers to the difference between the x- or y-axis (in-plane) and the z-axis (out-of-plane) refractive indices.

The term “charge transport,” when referring to a layer, material, member, or structure is intended to mean such layer, material, member, or structure facilitates migration of such charge through the thickness of such layer, material, member, or structure with relative efficiency and small loss of charge. Hole transport materials facilitate positive charge; electron transport materials facilitate negative charge. Although light-emitting materials may also have some charge transport properties, the term “charge transport layer, material, member, or structure” is not intended to include a layer, material, member, or structure whose primary function is light emission.

The term “coating” is intended to mean a layer of any substance spread over a surface. It can also refer to the process of applying the substance to a surface. The term “spin coating” is intended to mean a particular process used to deposit uniform thin films onto flat substrates. Generally, in “spin coating,” a small amount of coating material is applied on the center of the substrate, which is either spinning at low speed or not spinning at all. The substrate is then rotated at specified speeds in order to spread the coating material uniformly by centrifugal force.

The term “compound” is intended to mean an electrically uncharged substance made up of molecules that further include atoms, wherein the atoms cannot be separated from their corresponding molecules by physical means without breaking chemical bonds. The term is intended to include oligomers and polymers.

The term “crosslinkable group” or “crosslinking group” is intended to mean a group on a compound or polymer chain than can link to another compound or polymer chain via thermal treatment, use of an initiator, or exposure to radiation, where the link is a covalent bond. In some embodiments, the radiation is UV or visible. Examples of crosslinkable groups include, but are not limited to vinyl, acrylate, perfluorovinylether, 1-benzo-3,4-cyclobutane, o-quinodimethane groups, siloxane, cyanate groups, cyclic ethers (epoxides), internal alkenes (e.g., stillbene) cycloalkenes, and acetylenic groups.

The term “linear coefficient of thermal expansion (CTE or a)” is intended to mean the parameter that defines the amount which a material expands or contracts as a function of temperature. It is expressed as the change in length per degree Celsius and is generally expressed in units of μm/m/° C. or ppm/° C.

α=(ΔL/L₀)/ΔT

Measured CTE values disclosed herein are made via known methods during the second heating scan between 50° C. and 250° C. The understanding of the relative expansion/contraction characteristics of materials can be an important consideration in the fabrication and/or reliability of electronic devices.

The term “dopant” is intended to mean a material, within a layer including a host material, that changes the electronic characteristic(s) or the targeted wavelength(s) of radiation emission, reception, or filtering of the layer compared to the electronic characteristic(s) or the wavelength(s) of radiation emission, reception, or filtering of the layer in the absence of such material.

The term “electroactive” as it refers to a layer or a material, is intended to indicate a layer or material which electronically facilitates the operation of the device. Examples of electroactive materials include, but are not limited to, materials which conduct, inject, transport, or block a charge, where the charge can be either an electron or a hole, or materials which emit radiation or exhibit a change in concentration of electron-hole pairs when receiving radiation. Examples of inactive materials include, but are not limited to, planarization materials, insulating materials, and environmental barrier materials.

The term “tensile elongation” or “tensile strain” is intended to mean the percentage increase in length that occurs in a material before it breaks under an applied tensile stress. It can be measured, for example, by ASTM Method D882.

The prefix “fluoro” is intended to indicate that one or more hydrogens in a group have been replaced with fluorine.

The term “glass transition temperature (or T_{g})” is intended to mean the temperature at which a reversible change occurs in an amorphous polymer or in amorphous regions of a semi crystalline polymer where the material changes suddenly from a hard, glassy, or brittle state to one that is flexible or elastomeric. Microscopically, the glass transition occurs when normally-coiled, motionless polymer chains become free to rotate and can move past each other. T_{g}'s may be measured using differential scanning calorimetry (DSC), thermo-mechanical analysis (TMA), or dynamic-mechanical analysis (DMA), or other methods.

The prefix “hetero” indicates that one or more carbon atoms have been replaced with a different atom. In some embodiments, the heteroatom is O, N, S, or combinations thereof.

The term “host material” is intended to mean a material to which a dopant is added. The host material may or may not have electronic characteristic(s) or the ability to emit, receive, or filter radiation. In some embodiments, the host material is present in higher concentration.

The term “isothermal weight loss” is intended to mean a material's property that is directly related to its thermal stability. It is generally measured at a constant temperature of interest via thermogravimetric analysis (TGA). Materials that have high thermal stability generally exhibit very low percentages of isothermal weight loss at the required use or processing temperature for the desired period of time and can therefore be used in applications at these temperatures without significant loss of strength, outgassing, and/or change in structure.

The term “liquid composition” is intended to mean a liquid medium in which a material is dissolved to form a solution, a liquid medium in which a material is dispersed to form a dispersion, or a liquid medium in which a material is suspended to form a suspension or an emulsion.

The term “matrix” is intended to mean a foundation on which one or more layers is deposited in the formation of, for example, an electronic device. Non-limiting examples include glass, silicon, and others.

The term “1% TGA Weight Loss” is intended to mean the temperature at which 1% of the original polymer weight is lost due to decomposition (excluding absorbed water).

The term “optical retardation (or R_{TH})” is intended to mean the difference between the average in-plane refractive index and the out-of-plane refractive index (i.e., the birefringence), this difference then being multiplied by the thickness of the film or coating. Optical retardation is typically measured for a given frequency of light, and the units are reported in nanometers.

The term “organic electronic device” or sometimes “electronic device” is herein intended to mean a device including one or more organic semiconductor layers or materials.

The term “particle content” is intended to mean the number or count of insoluble particles that is present in a solution. Measurements of particle content can be made on the solutions themselves or on finished materials (pieces, films, etc.) prepared from those films. A variety of optical methods can be used to assess this property.

The term “photoactive” refers to a material or layer that emits light when activated by an applied voltage (such as in a light emitting diode or chemical cell), that emits light after the absorption of photons (such as in down-converting phosphor devices), or that responds to radiant energy and generates a signal with or without an applied bias voltage (such as in a photodetector or a photovoltaic cell).

The term “polyamic acid solution” refers to a solution of a polymer containing amic acid units that have the capability of intramolecular cyclization to form imide groups.

The term “polyimide” refers to condensation polymers derived from bifunctional carboxylic acid anhydrides and primary diamines. They contain the imide structure —CO—NR—CO— as a linear or heterocyclic unit along the main chain of the polymer backbone.

The term “quadrivalent” is intended to mean an atom that has four electrons available for covalent chemical bonding and can therefore form four covalent bonds with other atoms.

The term “satisfactory,” when regarding a materials property or characteristic, is intended to mean that the property or characteristic fulfills all requirements/demands for the material in-use. For example, an isothermal weight loss of less than 1% at 400° C. for 3 hours in nitrogen can be viewed as a non-limiting example of a “satisfactory” property in the context of the polyimide films disclosed herein.

The term “soft-baking” is intended to mean a process commonly used in electronics manufacture wherein spin-coated materials are heated to drive off solvents and solidify a film. Soft-baking is commonly performed on a hot plate or in exhausted oven at temperatures between 90° C. and 110° C. as a preparation step for subsequent thermal treatment of coated layers or films.

The term “substrate” refers to a base material that can be either rigid or flexible and may include one or more layers of one or more materials, which can include, but are not limited to, glass, polymer, metal or ceramic materials or combinations thereof. The substrate may or may not include electronic components, circuits, or conductive members.

The term “siloxane” refers to the group R₃SiOR₂Si—, where R is the same or different at each occurrence and is H, D, C1-20 alkyl, deuterated alkyl, fluoroalkyl, aryl, or deuterated aryl. In some embodiments, one or more carbons in an R alkyl group are replaced with Si. A deuterated siloxane group is one in which one or more R groups are deuterated.

The term “siloxy” refers to the group R₃SiO—, where R is the same or different at each occurrence and is H, D, C1-20 alkyl, deuterated alkyl, fluoroalkyl, aryl, or deuterated aryl. A deuterated siloxy group is one in which one or more R groups are deuterated.

The term “silyl” refers to the group R₃Si—, where R is the same or different at each occurrence and is H, D, C1-20 alkyl, deuterated alkyl, fluoroalkyl, aryl, or deuterated aryl. In some embodiments, one or more carbons in an R alkyl group are replaced with Si. A deuterated silyl group is one in which one or more R groups are deuterated.

The term “laser particle counter test” refers to a method used to assess the particle content of polyamic acid and other polymeric solutions whereby a representative sample of a test solution is spin coated onto a 5″ silicon wafer and soft baked/dried. The film thus prepared is evaluated for particle content by any number of standard measurement techniques. Such techniques include laser particle detection and others known in the art.

The term “tensile modulus” is intended to mean the measure of the stiffness of a solid material that defines the initial relationship between the stress (force per unit area) and the strain (proportional deformation) in a material like a film. Commonly used units are giga pascals (GPa).

The term “tensile strength” is intended to mean the measure of the maximum stress that a material can withstand while being stretched or pulled before breaking. In contrast to “tensile modulus,” which measures how much a material deforms elastically per unit tensile stress applied, the “tensile strength” of a material is the maximum amount of tensile stress that it can take before failure. Commonly used units are mega pascals (MPa).

The term “tensile elongation” is intended to mean the percentage increase in length that occurs in a material before it breaks under an applied tensile stress. It can be measured, for example, by ASTM Method D882 and is a unitless quantity.

The term “tetracarboxylic acid component” is intended to mean the quadrivalent moiety bonded to four carboxy groups in a tetracarboxylic acid compound. The tetracarboxylic acid compound can be a tetracarboxylic acid, a tetracarboxylic acid monoanhydride, a tetracarboxylic acid dianhydride, a tetracarboxylic acid monoester, or a tetracarboxylic acid diester. The tetracarboxylic acid component is derived from a tetracarboxylic acid compound. The tetracarboxylic acid component may also be described as being made from a tetracarboxylic acid compound.

The term “transparent” or “transparency” refers to the physical property of a material whereby light is allowed to pass through the material without being scattered. It can be true that materials exhibiting high transparency also exhibit low optical retardation and/or low birefringence. The term “transmittance” refers to the percentage of light of a given wavelength impinging on a film that passes through the film so as to be present or detectable on the other side. Light transmittance measurements in the visible region (380 nm to 800 nm) are particularly useful for characterizing film-color characteristics that are most important for understanding the properties-in-use of the polyimide films disclosed herein. Additionally, radiation of certain wavelengths is often used in the production of films for use in organic electronic devices like OLEDS so that additional “transmittance” criteria are specified. After a display is constructed, for example, a laser lift-off process is used to remove a polyimide film from the glass onto which it was cast. The laser wavelength commonly used for this process is either 308 nm or 355 nm. It is therefore desirable for polyimide films in the current context to have near-zero transmittance at these wavelengths. Further, during display-device construction some process steps may be accomplished using the process of photolithography; wherein a photopolymer is exposed through a glass substrate and the polyimide coating. Given that photolithography radiation commonly has a wavelength of 365 nm, it is desirable for polyimide films in the current context to have at least some transmittance at this wavelength (typically at least 15%) to enable adequate photopolymer exposure.

The term “yellowness index (or YI)” refers to the magnitude of yellowness relative to a standard. A positive value of YI indicates the presence, and magnitude, of a yellow color. Materials with a negative YI appear bluish. It should also be noted, particularly for polymerization and/or curing processes run at high temperatures, that YI can be solvent dependent. The magnitude of color introduced using DMAC as a solvent, for example, may be different than that introduced using NMP as a solvent. This may arise as the result of inherent properties of the solvent and/or properties associated with low levels of impurities contained in various solvents. Particular solvents are often preselected to achieve desired YI values for a particular application.

In a structure where a substituent bond passes through one or more rings as shown below,

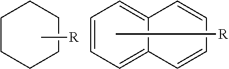

it is meant that the substituent R may be bonded at any available position on the one or more rings.

The phrase “adjacent to,” when used to refer to layers in a device, does not necessarily mean that one layer is immediately next to another layer. On the other hand, the phrase “adjacent R groups,” is used to refer to R groups that are next to each other in a chemical formula (i.e., R groups that are on atoms joined by a bond). Exemplary adjacent R groups are shown below:

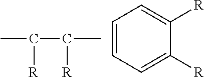

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the disclosed subject matter hereof, is described as consisting essentially of certain features or elements, in which embodiment features or elements that would materially alter the principle of operation or the distinguishing characteristics of the embodiment are not present therein. A further alternative embodiment of the described subject matter hereof is described as consisting of certain features or elements, in which embodiment, or in insubstantial variations thereof, only the features or elements specifically stated or described are present.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Group numbers corresponding to columns within the Periodic Table of the elements use the “New Notation” convention as seen in the CRC Handbook of Chemistry and Physics, 81^{st} Edition (2000-2001).

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductive member arts.

### 2. Polyimide Films Having the Repeat Unit Structure in Formula I

There is provided a solution containing a polyamic acid in a high-boiling, aprotic solvent; wherein the polyamic acid comprises one or more tetracarboxylic acid components and one or more diamine components; and wherein at least one of the tetracarboxylic acid components is a quadrivalent organic group derived from a bent dianhydride or an aromatic dianhydride comprising —O—, —CO—, —NHCO—, —S—, —SO—, —CO—O—, or —CR₂-links, or a direct chemical bond between aromatic rings; and wherein at least one of the diamine components is a divalent organic group derived from a bent diamine or an aromatic diamine comprising —O—, —CO—, —NHCO—, —S—, —SO₂—, —CO—C—, or —CR₂— links, or a direct chemical bond between aromatic rings; and wherein

R is the same or different at each occurrence and is selected from the group consisting of H, F, alkyl, and fluoroalkyl.

There is further provided a polyimide film generated from a solution containing a polyamic acid in a high-boiling, aprotic solvent; wherein the polyamic acid comprises one or more tetracarboxylic acid components and one or more diamine components; and wherein at least one of the tetracarboxylic acid components is a quadrivalent organic group derived from a bent dianhydride or an aromatic dianhydride comprising —O—, —CO—, —NHCO—, —S—, —SO₂—, —CO—O—, or —CR₂— links, or a direct chemical bond between aromatic rings; and wherein at least one of the diamine components is a divalent organic group derived from a bent diamine or an aromatic diamine comprising —O—, —CO—, —NHCO—, —S—, —SO₂—, —CO—O—, or —CR₂ links, or a direct chemical bond between aromatic rings; and wherein

R is the same or different at each occurrence and is selected from the group consisting of H, F, alkyl, and fluoroalkyl.

The tetracarboxylic acid components are made from the corresponding dianhydride monomers, where the dianhydride monomers are selected from the group consisting of 4,4′-oxydiphthalic anhydride (ODPA), 4,4′-hexafluoroiso-propylidenebisphthalic dianhydride (6FDA), 3,3′,4,4′-benzophenone tetracarboxylic dianhydride (BTDA), 3,3′,4,4′-diphenylsulfone tetracarboxylic dianhydride (DSDA), 4,4′-bisphenol-A dianhydride (BPADA), asymmetric 2,3,3′,4′-biphenyltetracarboxylic dianhydride (a-BPDA), hydroquinone diphthalic anhydride (HQDEA), ethylene glycol bis (trimellitic anhydride) (TMEG-100), bis(1,3-dioxo-1,3-dihydroisobenzofuran-5-carboxylic acid) 1,4-phenylene ester (TAHQ or M1225), and the like and combinations thereof.

In some embodiments, additional dianhydride monomers are used. Nonlimiting examples of these include pyromellitic dianhydride (PMDA), 3,3′,4,4′-biphenyl tetracarboxylic dianhydride (BPDA), and the like and combinations thereof.

In some embodiments, monoanhydride monomers are also used as end-capping groups.

In some embodiments, the monoanhydride monomers are selected from the group consisting of phthalic anhydrides and the like and derivatives thereof.

In some embodiments, the monoanhydrides are present at an amount up to 5% of the total tetracarboxylic acid composition.

The diamine components result from the corresponding diamine monomers which are selected from the group consisting of 2,2-bis[4-(4-aminophenoxy)phenyl]propane (BAPP), 2,2′-bis(trifluoromethyl) benzidine (TFMB), 4,4′-methylene dianiline (MDA), 4,4′-[1,3-phenylenebis(1-methyl-ethylidene)]bisaniline (Bis-M), 4,4′-[1,4-phenylenebis(1-methyl-ethylidene)]bisaniline (Bis-P), 4,4′-oxydianiline (4,4′-ODA), m-phenylene diamine (MPD), 3,4′-oxydianiline (3,4′-ODA), 3,3′-diaminodiphenyl sulfone (3,3′-DDS), 4,4′-diaminodiphenyl sulfone (4,4′-DDS), 4,4′-diaminodiphenyl sulfide (ASD), 2,2-bis[4-(4-amino-phenoxy)phenyl]sulfone (BAPS), 2,2-bis[4-(3-aminophenoxy)-phenyl]sulfone (m-BAPS), 1,4′-bis(4-aminophenoxy)benzene (TPE-Q), 1,3′-bis(4-aminophenoxy)benzene (TPE-R), 1,3′-bis(4-amino-phenoxy)benzene (APB-133), 4,4′-bis(4-aminophenoxy)biphenyl (BAPB), 4,4′-diaminobenzanilide (DABA), methylene bis(anthranilic acid) (MBAA), 1,3′-bis(4-aminophenoxy)-2,2-dimethylpropane (DANPG), 1,5-bis(4-aminophenoxy)pentane (DASMG), 2,2′-bis[4-(4-aminophenoxy pehnyl)]hexafluoropropane (HFBAPP), 2,2-bis(4-aminophenyl) hexafluoropropane (Bis-A-AF), 2,2-bis(3-amino-4-hydroxyphenyl) hexafluoropropane (Bis-AP-AF), 2,2-bis(3-amino-4-methylphenyl) hexafluoropropane (Bis-AT-AF), 4,4′-bis(4-amino-2-trifluoromethyl phenoxy)biphenyl (6BFBAPB), 3,3′5,5′-tetramethyl-4,4′-diamino diphenylmethane (TMMDA), and the like and combinations thereof.

In some embodiments, additional diamine monomers are used. Nonlimiting examples of these include p-phenylene diamine (PPD), 2,2′-dimethyl-4,4′-diaminobiphenyl (m-tolidine), 3,3′-dimethyl-4,4′-diaminobiphenyl (o-tolidine), 3,3′-dihydroxy-4,4′-diaminobiphenyl (HAB), 9,9′-bis(4-aminophenyl)fluorene (FDA), o-tolidine sulfone (TSN), 2,3,5,6-tetramethyl-1,4-phenylenediamine (TMPD), 2,4-diamino-1,3,5-trimethyl benzene (DAM), 3,3′,5,5′-tetramethylbenzidine (3355TMB), 2,2′-bis(trifluoromethyl) benzidine (22TFMB or TFMB), and the like and combinations thereof.

In some embodiments, monoamine monomers are also used as end-capping groups.

In some embodiments, the monoamine monomers are selected from the group consisting of aniline and the like and derivatives thereof.

In some embodiments, the monoamines are present at an amount up to 5% of the total amine composition.

High-boiling polar aprotic solvents are selected from the group consisting of N-methyl-2-pyrrolidone (NMP), dimethyl acetamide (DMAc), dimethyl sulfoxide (DMSO), dimethyl formamide (DMF), γ-butyrolactone, dibutyl carbitol, butyl carbitol acetate, diethylene glycol monoethyl ether acetate, propylene glycol monomethyl ether acetate and the like and combinations thereof.

In some embodiments, the polyamic acid contains one tetracarboxylic acid component.

In some embodiments, the polyamic acid contains two tetracarboxylic acid components.

In some embodiments, the polyamic acid contains three tetracarboxylic acid components.

In some embodiments, the polyamic acid contains four or more tetracarboxylic acid components.

In some embodiments, one of the tetracarboxylic acid components of the polyamic acid is 4,4′-oxydiphthalic anhydride (ODPA).

In some embodiments, one of the tetracarboxylic acid components of the polyamic acid is 4,4′-Hexafluoroiso-propylidenebisphthalic dianhydride (6FDA).

In some embodiments, one or more of the tetracarboxylic acid components of the polyamic acid is a quadrivalent organic group derived from a bent dianhydride or an aromatic dianhydride comprising —O—, —CO—, —NHCO—, —S—, —SO₂—, —CO—O—, or —CR₂— links, or a direct chemical bond between aromatic rings as disclosed herein.

In some embodiments, one or more of the tetracarboxylic acid components of the polyamic acid is a dianhydride that is more conventionally considered to be rigid at room temperature as disclosed herein.

In some embodiments, the polyamic acid contains one tetracarboxylic acid components wherein the tetracarboxylic acid component is present in a mole percent of 100%.

In some embodiments, the polyamic acid contains two tetracarboxylic acid components wherein each tetracarboxylic acid component is present in a mole percent between 0.1% and 99.9%.

In some embodiments, the polyamic acid contains three tetracarboxylic acid components wherein each tetracarboxylic acid component is present in a mole percent between 0.1% and 99.9%.

In some embodiments, the polyamic acid contains four or more tetracarboxylic acid components wherein each tetracarboxylic acid component is present in a mole percent between 0.1% and 99.9%.

In some embodiments, the tetracarboxylic acid component of the polyamic acid is 100% 4,4′-oxydiphthalic anhydride (ODPA).

In some embodiments, the tetracarboxylic acid component of the polyamic acid is 90% 4,4′-oxydiphthalic anhydride (ODPA) and 10% of one or more of the other dianhydride compounds disclosed herein.

In some embodiments, the tetracarboxylic acid component of the polyamic acid is 80% 4,4′-oxydiphthalic anhydride (ODPA) and 20% of one or more of the other dianhydride compounds disclosed herein.

In some embodiments, the tetracarboxylic acid component of the polyamic acid is 70% 4,4′-oxydiphthalic anhydride (ODPA) and 30% of one or more of the other dianhydride compounds disclosed herein.

In some embodiments, the tetracarboxylic acid component of the polyamic acid is 60% 4,4′-oxydiphthalic anhydride (ODPA) and 40% of one or more of the other dianhydride compounds disclosed herein.

In some embodiments, the tetracarboxylic acid component of the polyamic acid is 50% 4,4′-oxydiphthalic anhydride (ODPA) and 50% of one or more of the other dianhydride compounds disclosed herein.

In some embodiments, the polyamic acid contains one monomeric diamine component.

In some embodiments, the polyamic acid contains two monomeric diamine components.

In some embodiments, the polyamic acid contains three or more monomeric diamine components.

In some embodiments, monomeric diamine component of the polyamic acid is 4,4′-[1,4-phenylenebis(1-methyl-ethylidene)]bisaniline (Bis-P).

In some embodiments, monomeric diamine component of the polyamic acid is 1,3′-bis(4-amino-phenoxy)benzene (APB-133).

In some embodiments, monomeric diamine component of the polyamic acid is 2,2′-bis(trifluoromethyl) benzidine (TFMB).

In some embodiments, monomeric diamine component of the polyamic acid is benzene-1,3-diamine (MPD).

In some embodiments, monomeric diamine component of the polyamic acid is 3,3′-sulfonyldianiline (DDS).

In some embodiments, monomeric diamine component of the polyamic acid is 2,2-bis-[4-(4-aminophenoxyphenyl)] hexafluoro-propane (HFBAPP).

In some embodiments, with one monomeric diamine components of the polyamic acid, the mole percentage of the one monomeric diamine component is 100%.

In some embodiments, with two monomeric diamine components of the polyamic acid, the mole percentages of each of the two monomeric diamine components is between 0.1% and 99.9%.

In some embodiments, with three monomeric diamine components of the polyamic acid, the mole percentages of each of the three monomeric diamine components is between 0.1% and 99.9%.

In some embodiments, with four or more monomeric diamine components of the polyamic acid, the mole percentages of each of the four or more monomeric diamine components is between 0.1% and 99.9%.

In some embodiments, the monomeric diamine component of the polyamic acid in mole percent is 95% 4,4′-[1,4-phenylenebis(1-methyl-ethylidene) ]bisaniline (Bis-P) and 5% 2,2′-bis(trifluoromethyl) benzidine (TFMB).

In some embodiments, the monomeric diamine component of the polyamic acid in mole percent is 90% 4,4′-[1,4-phenylenebis(1-methyl-ethylidene)]bisaniline (Bis-P) and 10% 2,2′-bis(trifluoromethyl) benzidine (TFMB).

In some embodiments, the monomeric diamine component of the polyamic acid in mole percent is 80% 4,4′-[1,4-phenylenebis(1-methyl-ethylidene)]bisaniline (Bis-P) and 20% 2,2′-bis(trifluoromethyl) benzidine (TFMB).

In some embodiments, the monomeric diamine component of the polyamic acid in mole percent is 70% 4,4′-[1,4-phenylenebis(1-methyl-ethylidene)]bisaniline (Bis-P) and 30% 2,2′-bis(trifluoromethyl) benzidine (TFMB).

In some embodiments, the monomeric diamine component of the polyamic acid in mole percent is 60% 4,4′-[1,4-phenylenebis(1-methyl-ethylidene)]bisaniline (Bis-P) and 40% 2,2′-bis(trifluoromethyl) benzidine (TFMB).

In some embodiments, the monomeric diamine component of the polyamic acid in mole percent is 50% 4,4′-[1,4-phenylenebis(1-methyl-ethylidene)]bisaniline (Bis-P) and 50% 2,2′-bis(trifluoromethyl) benzidine (TFMB).

In some embodiments, the monomeric diamine component of the polyamic acid in mole percent is 95% 2,2′-bis(trifluoromethyl) benzidine (TFMB) and 5% 1,3′-bis(4-amino-phenoxy)benzene (APB-133).

In some embodiments, the monomeric diamine component of the polyamic acid in mole percent is 90% 2,2′-bis(trifluoromethyl) benzidine (TFMB) and 10% 1,3′-bis(4-amino-phenoxy)benzene (APB-133).

In some embodiments, the monomeric diamine component of the polyamic acid in mole percent is 80% 2,2′-bis(trifluoromethyl) benzidine (TFMB) and 20% 1,3′-bis(4-amino-phenoxy)benzene (APB-133).

In some embodiments, the monomeric diamine component of the polyamic acid in mole percent is 70% 2,2′-bis(trifluoromethyl) benzidine (TFMB) and 30% 1,3′-bis(4-amino-phenoxy)benzene (APB-133).

In some embodiments, the monomeric diamine component of the polyamic acid in mole percent is 60% 2,2′-bis(trifluoromethyl) benzidine (TFMB) and 40% 1,3′-bis(4-amino-phenoxy)benzene (APB-133).

In some embodiments, the monomeric diamine component of the polyamic acid in mole percent is 50% 2,2′-bis(trifluoromethyl) benzidine (TFMB) and 50% 1,3′-bis(4-amino-phenoxy)benzene (APB-133).

In some embodiments, the mole ratio of the tetracarboxylic acid component to the diamine component of the polyamic acid is 50/50.

In some embodiments, the solvent in the solution containing the polyamic acid is N-methyl-2-Pyrrolidone (NMP).

In some embodiments, the solvent in the solution containing the polyamic acid is dimethyl acetamide (DMAc).

In some embodiments, the solvent in the solution containing the polyamic acid is dimethyl formamide (DMF).

In some embodiments, the solvent in the solution containing the polyamic acid is y-butyrolactone.

In some embodiments, the solvent in the solution containing the polyamic acid is dibutyl carbitol.

In some embodiments, the solvent in the solution containing the polyamic acid is butyl carbitol acetate.

In some embodiments, the solvent in the solution containing the polyamic acid is diethylene glycol monoethyl ether acetate.

In some embodiments, the solvent in the solution containing the polyamic acid is propylene glycol monoethyl ether acetate.

In some embodiments, more than one of the high-boiling aprotic solvents identified above is used in the solution containing the polyamic acid.

In some embodiments, additional cosolvents are used in the solution containing the polyamic acid.

In some embodiments, the solution containing the polyamic acid is <1 weight % polymer in >99 weight % high-boiling polar aprotic solvent.

In some embodiments, the solution containing the polyamic acid is 1-5 weight % polymer in 95-99 weight % high-boiling polar aprotic solvent.

In some embodiments, the solution containing the polyamic acid is 5-10 weight % polymer in 90-95 weight % high-boiling polar aprotic solvent.

In some embodiments, the solution containing the polyamic acid is 10-15 weight % polymer in 85-90 weight % high-boiling polar aprotic solvent.

In some embodiments, the solution containing the polyamic acid is 15-20 weight % polymer in 80-85 weight % high-boiling polar aprotic solvent.

In some embodiments, the solution containing the polyamic acid is 20-25 weight % polymer in 75-80 weight % high-boiling polar aprotic solvent.

In some embodiments, the solution containing the polyamic acid is 25-30 weight % polymer in 70-75 weight % high-boiling polar aprotic solvent.

In some embodiments, the solution containing the polyamic acid is 30-35 weight % polymer in 65-70 weight % high-boiling polar aprotic solvent.

In some embodiments, the solution containing the polyamic acid is 35-40 weight % polymer in 60-65 weight % high-boiling polar aprotic solvent.

In some embodiments, the solution containing the polyamic acid is 40-45 weight % polymer in 55-60 weight % high-boiling polar aprotic solvent.

In some embodiments, the solution containing the polyamic acid is 45-50 weight % polymer in 50-55 weight % high-boiling polar aprotic solvent.

In some embodiments, the solution containing the polyamic acid is 50 weight % polymer in 50 weight % high-boiling polar aprotic solvent.

In some embodiments, the polyamic acid has a weight average molecular weight (M_{w}) greater than 100,000 based on gel permeation chromatography with polystyrene standards.

In some embodiments, the polyamic acid has a weight average molecular weight (M_{w}) greater than 150,000 based on gel permeation chromatography with polystyrene standards.

In some embodiments, the polyamic acid has a molecular weight (M_{w}) greater than 200,000 based on gel permeation chromatography with polystyrene standards.

In some embodiments, the polyamic acid has a weight average molecular weight (M_{w}) greater than 250,000 based on gel permeation chromatography with polystyrene standards.

In some embodiments, the polyamic acid has a weight average molecular weight (M_{w}) between 200,000 and 300,000 based on gel permeation chromatography with polystyrene standards.

In some embodiments, the polyamic acid has a weight average molecular weight (M_{w}) greater than 300,000 based on gel permeation chromatography with polystyrene standards.

The solutions containing the polyamic acids disclosed herein may be prepared using a variety of available methods with respect to how the components (i.e., the monomers and solvents) are introduced to one another. Numerous variations of producing a polyamic acid solution include:
(a) a method wherein the diamine components and dianhydride components are preliminarily mixed together and then the mixture is added in portions to a solvent while stirring.
(b) a method wherein a solvent is added to a stirring mixture of diamine and dianhydride components. (contrary to (a) above)
(c) a method wherein diamines are exclusively dissolved in a solvent and then dianhydrides are added thereto at such a ratio as allowing to control the reaction rate.
(d) a method wherein the dianhydride components are exclusively dissolved in a solvent and then amine components are added thereto at such a ratio to allow control of the reaction rate.
(e) a method wherein the diamine components and the dianhydride components are separately dissolved in solvents and then these solutions are mixed in a reactor.
(f) a method wherein the polyamic acid with excessive amine component and another polyamic acid with excessive dianhydride component are preliminarily formed and then reacted with each other in a reactor, particularly in such a way as to create a non-random or block copolymer.
(g) a method wherein a specific portion of the amine components and the dianhydride components are first reacted and then the residual diamine components are reacted, or vice versa.
(h) a method wherein the components are added in part or in whole in any order to either part or whole of the solvent, also where part or all of any component can be added as a solution in part or all of the solvent.
(i) a method of first reacting one of the dianhydride components with one of the diamine components giving a first polyamic acid. Then reacting the other dianhydride component with the other amine component to give a second polyamic acid. Then combining the amic acids in any one of a number of ways prior to film formation.
   Generally speaking, a solution containing a polyamic acid can be derived from any one of the preparation methods disclosed above. Further, in some embodiments, the polyimide films and associated materials disclosed herein can be made from other suitable polyimide precursors such as poly(amic ester)s, polyisoimides, and polyamic acid salts. Further, if the polyimide is soluble in suitable coating solvents, it may be provided as an already-imidized polymer dissolved in the suitable coating solvent.

The solutions containing the polyamic acids disclosed herein can optionally further contain any one of a number of additives. Such additives can be: antioxidants, heat stabilizers, adhesion promoters, coupling agents (e.g. silanes), inorganic fillers or various reinforcing agents so long as they don't impact the desired polyimide properties.

The additives can be used in forming the polyimide films and can be specifically chosen to provide important physical attributes to the film. Beneficial properties commonly sought include, but are not limited to, high and/or low modulus, good mechanical elongation, a low coefficient of in-plane thermal expansion (CTE), a low coefficient of humidity expansion (CHE), high thermal stability, and a particular glass transition temperature (Tg).

The solution containing the polyamic acid can then be filtered one or more times so as to reduce the particle content. The polyimide film generated from such a filtered solution can show a reduced number of defects and thereby lead to superior performance in the electronics applications disclosed herein. An assessment of the filtration efficiency can be made by the laser particle counter test wherein a representative sample of the polyamic acid solution is cast onto a 5″ silicon wafer. After soft baking/drying, the film is evaluated for particle content by any number of laser particle counting techniques on instruments that are commercially available and known in the art.

In some embodiments, the solution containing the polyamic acid is prepared and filtered to yield a particle content of less than 40 particles as measured by the laser particle counter test.

In some embodiments, the solution containing the polyamic acid is prepared and filtered to yield a particle content of less than 30 particles as measured by the laser particle counter test.

In some embodiments, the solution containing the polyamic acid is prepared and filtered to yield a particle content of less than 20 particles as measured by the laser particle counter test.

In some embodiments, the solution containing the polyamic acid is prepared and filtered to yield a particle content of less than 10 particles as measured by the laser particle counter test.

In some embodiments, the solution containing the polyamic acid is prepared and filtered to yield particle content of between 2 particles and 8 particles as measured by the laser particle counter test.

In some embodiments, the solution containing the polyamic acid is prepared and filtered to yield particle content of between 4 particles and 6 particles as measured by the laser particle counter test.

Any of the above embodiments for the solution containing the polyamic acid can be combined with one or more of the other embodiments, so long as they are not mutually exclusive. For example, the embodiment in which the tetracarboxylic acid component of the polyamic acid is 4,4′-oxydiphthalic anhydride (ODPA) can be combined with the embodiment in which the solvent used in solution is N-methyl-2-pyrrolidone (NMP). The same is true for the other non-mutually-exclusive embodiments discussed above. The skilled person would understand which embodiments were mutually exclusive and would thus readily be able to determine the combinations of embodiments that are contemplated by the present application.

Exemplary preparations of solutions containing the polyamic acids are given in the examples. Overall solution compositions can be designated via the notation commonly used in the art. A solution containing the polyamic acid that is, in mole percent,

100% ODPA,

90% Bis-P, and

10% TFMB, for example, can be represented as:

ODPA//Bis-P/TFMB 100///90/10.

The solutions containing the polyamic acids disclosed herein may be used to generate polyimide films, wherein the polyimide films have the repeat unit of Formula I

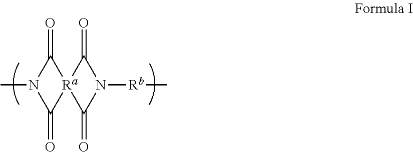

wherein:
R^{a} is a quadrivalent organic group derived from one or more acid dianhydrides selected from the group consisting of bent dianhydrides and aromatic dianhydrides containing one or more aromatic tetracarboxylic acid components comprising —O—, —CO—, —NHCO—, —S—, —SO₂—, —CO—C—, or —CR₂— chains, or a direct chemical bond between aromatic rings;
   and
R^{b} is a divalent organic group derived from one or more diamines selected from the group consisting of bent diamines and aromatic diamines comprising —O—, —CO—, —NHCO—, —S—, —SO₂, —CO—O—, or —CR₂— chains, or a direct chemical bond between aromatic rings;
   wherein:

R is the same or different at each occurrence and is selected from the group consisting of H, F, alkyl, and fluoroalkyl; such that:
the in-plane coefficient of thermal expansion (CTE) is less than 50 ppm/° C. between 50° C. and 250° C.;
the glass transition temperature (T_{g}) is greater than 250° C. for a polyimide film cured at 260° C. in air;
the 1% TGA weight loss temperature is greater than 350° C.;
the tensile modulus is between 1.5 GPa and 5.0 GPa;
the elongation to break is greater than 10%;
the optical retardation is less than 20 nm for a 10-μm film;
the birefringence at 633 nm is less than 0.007;
the haze is less than 1.0%;
the b* is less than 5;
the transmittance at 400 nm is greater than 45%;
the transmittance at 430 nm is greater than 80%;
the transmittance at 450 nm is greater than 85%;
the transmittance at 550 nm is greater than 88%; and
the transmittance at 750 nm is greater than 90%.

The R^{a} quadrivalent organic groups of the polyimide films are derived from one or more acid dianhydrides as disclosed herein for the corresponding solutions containing the polyamic acids.

The R^{b} divalent organic groups of the polyimide films are derived from one or more diamines as disclosed herein for the corresponding solutions containing the polyamic acids.

In some embodiments, the polyimide films disclosed herein have a glass transition temperature (T_{g}) that is greater than 200° C. for a polyimide film cured at 260° C. in air.

In some embodiments, the polyimide films disclosed herein have a glass transition temperature (T_{g}) that is greater than 225° C. for a polyimide film cured at 260° C. in air.

In some embodiments, the polyimide films disclosed herein have a glass transition temperature (T_{g}) that is greater than 230° C. for a polyimide film cured at 260° C. in air.

In some embodiments, the polyimide films disclosed herein have a glass transition temperature (T_{g}) that is greater than 240° C. for a polyimide film cured at 260° C. in air.

In some embodiments, the polyimide films disclosed herein have a glass transition temperature (T_{g}) that is greater than 250° C. for a polyimide film cured at 260° C. in air.

In some embodiments, the polyimide films disclosed herein have a glass transition temperature (T_{g}) that is greater than 260° C. for a polyimide film cured at 260° C. in air.

In some embodiments, the polyimide films disclosed herein have a glass transition temperature (T_{g}) that is greater than 270° C. for a polyimide film cured at 260° C. in air.

In some embodiments, the polyimide films disclosed herein have an optical retardation at 550 nm that is less than 100 nm for a 10-μm film.

In some embodiments, the polyimide films disclosed herein have an optical retardation at 550 nm that is less than 90 nm for a 10-μm film.

In some embodiments, the polyimide films disclosed herein have an optical retardation at 550 nm that is less than 80 nm for a 10-μm film.

In some embodiments, the polyimide films disclosed herein have an optical retardation at 550 nm that is less than 70 nm for a 10-μm film.

In some embodiments, the polyimide films disclosed herein have an optical retardation at 550 nm that is less than 60 nm for a 10-μm film.

In some embodiments, the polyimide films disclosed herein have an optical retardation at 550 nm that is less than 50 nm for a 10-μm film.

In some embodiments, the polyimide films disclosed herein have an optical retardation at 550 nm that is less than 40 nm for a 10-μm film.

In some embodiments, the polyimide films disclosed herein have an optical retardation at 550 nm that is less than 30 nm for a 10-μm film.

In some embodiments, the polyimide films disclosed herein have an optical retardation at 550 nm that is less than 20 nm for a 10-μm film.

In some embodiments, the polyimide films disclosed herein have an optical retardation at 550 nm that is less than 10 nm for a 10-μm film.

Any of the above embodiments for the polyimide film can be combined with one or more of the other embodiments, so long as they are not mutually exclusive. For example, the embodiment in which the tetracarboxylic acid component of the polyimide film is 4,4′-oxydiphthalic anhydride (ODPA) can be combined with the embodiment in which the glass transition temperature (T_{g}) of the film is greater than 200° C. The same is true for the other non-mutually-exclusive embodiments discussed above. The skilled person would understand which embodiments were mutually exclusive and would thus readily be able to determine the combinations of embodiments that are contemplated by the present application.

Exemplary preparations of polyimide films are given in the examples. Film compositions can also be designated via the notation commonly used in the art. A polyimide film that is, expressed in mole percent,

100% ODPA,

90% Bis-P, and

10% TFMB, for example, can be represented as:

ODPA//Bis-P/TFMB 100///90/10.

The one or more tetracarboxylic acid components and one or more diamine components disclosed herein can be combined in other proportions in the high-boiling, aprotic solvents disclosed herein to prepare solutions that can be used to generate polyimide films having different optical, thermal, electronic, and other properties than those already explicitly disclosed.

The utility of the polyimide films disclosed herein may be tailored to target electronic applications not only through judicious choice of dianhydride and diamine constituents, but also by careful selection of imidization-reaction conditions. When components of polyimide films exhibit a high degree of molecular flexibility, as do certain materials disclosed herein, the associated film properties can be unexpected versus related compounds. Films may be made which yield very low optical retardation combined with high optical transparency, low color, and T_{g}'s which make them suitable for processing and use in display touch panels and other end uses disclosed herein. By further incorporating rigid co-monomers (such as 2,2′-bis(trifluoromethyl) benzidine (TFMB), as disclosed herein, improvements in a film's optical transparency, reduction of its color, and increased T_{g} may be observed. All of these changes can be advantageous for the end uses disclosed herein.

A surprising and unexpected benefit of the above compositions is that properties such as low color can be achieved by thermal curing in an ambient-air atmosphere. The color is not negatively impacted by curing in an air relative to the more traditional approach of curing in a nitrogen, or other inert, atmosphere. This can have strategic advantages in practice as it enables the adoption of more flexible, and often lower cost, display manufacturing processes.

### 3. Methods for Preparing the Polyimide Films

There are provided thermal and modified-thermal methods for preparing a polyimide film, said methods generally comprising the following steps in order coating a solution containing a polyamic acid comprising one or more tetracarboxylic acid components and one or more diamine components in a high-boiling, aprotic solvent onto a matrix; soft-baking the coated matrix; treating the soft-baked, coated matrix at a plurality of pre-selected temperatures for a plurality of pre-selected time intervals whereby the polyimide film exhibits properties that are satisfactory for use in electronics applications like those disclosed herein.

Generally, polyimide films can be prepared from the corresponding solutions containing polyamic acids by chemical or thermal conversion processes. The polyimide films disclosed herein, particularly when used as flexible replacements for glass in electronic devices, are prepared by thermal conversion or modified-thermal conversion processes, versus chemical conversion processes.

Such processes may or may not employ conversion chemicals (i.e., catalysts) to convert a polyamic acid casting solution to a polyimide. If conversion chemicals are used, the process may be considered a modified-thermal conversion process. In both types of thermal conversion processes, only heat energy is used to heat the film to both dry the film of solvent and to perform the imidization reaction. Thermal conversion processes without conversion catalysts are generally used to prepare the polyimide films disclosed herein.

Specific method parameters are pre-selected considering that it is not just the film composition that yields the properties of interest. Rather, the cure temperature and temperature-ramp profile both also play important roles in the achievement of the most desirable properties for the intended uses disclosed herein. The polyamic acids should be imidized at a temperature at, or higher than, the highest temperature of any subsequent processing steps (e.g. deposition of inorganic or other layer(s) necessary to produce a functioning display), but at a temperature which is lower than the temperature at which significant thermal degradation/discoloration of the polyimide occurs. Imidization temperatures employed, therefore, can be quite different depending up the resulting film's intended use in an electronic device—higher temperatures are generally appropriate for preparing polyimides for device substrates, while relatively low temperatures can be advantageous for touch screen panels, cover films, and other applications disclosed herein. In some embodiments of the imidization process, an inert atmosphere may be preferred, particularly when higher processing temperatures are employed for imidization. In other embodiments, however, the imidization reaction can be run in ambient air. This can offer process benefits that include overall cost and simplicity.

For some of the polyamic acids/polyimides disclosed herein, maximum imidization temperatures of 260° C. are employed because subsequent processing steps do not expose the film to temperatures above this maximum. In some embodiments of this process the 260° C. maximum temperature is maintained for 1 hour as the final step in the temperature-ramp profile. The proper curing temperature and time allow the production cured polyimide which exhibits appropriate thermal, mechanical, and optical properties for the targeted display application. A benefit of such a relatively-low-temperature cure process, with a 260° C. maximum temperature, is that an inert atmosphere is not required. None of the degradation in film optical properties is observed as might be the case for imidization processes run at higher temperatures in the presence of oxygen.

There are cases, though, where higher-temperature imidization processes are appropriate. In some embodiments of the polyamic acids/polyimides disclosed herein, temperatures of 325° C. to 375° C. are employed since subsequent processing temperatures in excess of 350° C. are required, e.g., for device substrate applications. Choosing the proper curing temperature allows a fully cured polyimide which achieves the best balance of thermal, mechanical, and optical properties. Because of this very high temperature, an inert atmosphere is required in these process embodiments. Typically, oxygen levels of less than 100 ppm should be employed. Very low oxygen levels enable the highest curing temperatures to be used without significant degradation and/or discoloration of the polymer.

The amount of time used in each potential cure step is also an important process consideration in all process embodiments. Generally, the time used for the highest-temperature curing should be kept to a minimum. For 350° C. cure, for example, cure time can be up to an hour or so under an inert atmosphere; but at 400° C., this time should be shortened to avoid thermal degradation. For imidization at or below 260° C., cure times can be an hour or more, but an inert atmosphere may not be required in some embodiments. Generally speaking, higher temperature dictates shorter time and the absence of atmospheric oxygen. Those skilled in the art will recognize the balance required to optimize the properties of the polyimide for a particular end use.

In some embodiments, the solution containing the polyamic acid is converted into a polyimide film via a thermal conversion process.

In some embodiments of the thermal conversion process, the solution containing the polyamic acid is coated onto the matrix such that the soft-baked thickness of the resulting film is between 10 μm and 20 μm.

In some embodiments of the thermal conversion process, the solution containing the polyamic acid is coated onto the matrix such that the soft-baked thickness of the resulting film is less than 10 μm.

In some embodiments of the thermal conversion process, the coated matrix is soft baked on a hot plate in proximity mode wherein nitrogen gas is used to hold the spin-coated matrix just above the hot plate.

In some embodiments of the thermal conversion process, the coated matrix is soft baked on a hot plate in full-contact mode wherein the coated matrix is in direct contact with the hot plate surface.

In some embodiments of the thermal conversion process, the coated matrix is soft baked on a hot plate using a combination of proximity and full-contact modes.

In some embodiments of the thermal conversion process, the coated matrix is soft-baked using a hot plate set at 110° C.

In some embodiments of the thermal conversion process, the coated matrix is soft-baked for a total time of less than 10 minutes.

In some embodiments of the thermal conversion process, the soft-baked, coated matrix is subsequently cured at 2 pre-selected temperatures for 2 pre-selected time intervals, the latter of which may be the same or different.

In some embodiments of the thermal conversion process, the soft-baked, coated matrix is subsequently cured at 3 pre-selected temperatures for 3 pre-selected time intervals, each of which of the latter of which may be the same or different.

In some embodiments of the thermal conversion process, the soft-baked, coated matrix is subsequently cured at 4 pre-selected temperatures for 4 pre-selected time intervals, each of which of the latter of which may be the same or different.

In some embodiments of the thermal conversion process, the soft-baked, coated matrix is subsequently cured at 5 pre-selected temperatures for 5 pre-selected time intervals, each of which of the latter of which may be the same or different.

In some embodiments of the thermal conversion process, the soft-baked, coated matrix is subsequently cured at 6 pre-selected temperatures for 6 pre-selected time intervals, each of which of the latter of which may be the same or different.

In some embodiments of the thermal conversion process, the soft-baked, coated matrix is subsequently cured at 7 pre-selected temperatures for 7 pre-selected time intervals, each of which of the latter of which may be the same or different.

In some embodiments of the thermal conversion process the soft-baked, coated matrix is subsequently cured at 8 pre-selected temperatures for 8 pre-selected time intervals, each of which of the latter of which may be the same or different.

In some embodiments of the thermal conversion process, the soft-baked, coated matrix is subsequently cured at 9 pre-selected temperatures for 9 pre-selected time intervals, each of which of the latter of which may be the same or different.

In some embodiments of the thermal conversion process, the soft-baked, coated matrix is subsequently cured at 10 pre-selected temperatures for 10 pre-selected time intervals, each of which of the latter of which may be the same or different.

In some embodiments of the thermal conversion process, the pre-selected temperature is greater than 80° C.

In some embodiments of the thermal conversion process, the pre-selected temperature is equal to 100° C.

In some embodiments of the thermal conversion process, the pre-selected temperature is greater than 100° C.

In some embodiments of the thermal conversion process, the pre-selected temperature is equal to 150° C.

In some embodiments of the thermal conversion process, the pre-selected temperature is greater than 150° C.

In some embodiments of the thermal conversion process, the pre-selected temperature is equal to 200° C.

In some embodiments of the thermal conversion process, the pre-selected temperature is greater than 200° C.

In some embodiments of the thermal conversion process, the pre-selected temperature is equal to 250° C.

In some embodiments of the thermal conversion process, the pre-selected temperature is greater than 250° C.

In some embodiments of the thermal conversion process, the pre-selected temperature is 260° C.

In some embodiments of the thermal conversion process, the pre-selected temperature does not exceed 260° C.

In some embodiments of the thermal conversion process, the pre-selected temperature is greater than 260° C.

In some embodiments of the thermal conversion process, the pre-selected temperature is 280° C.

In some embodiments of the thermal conversion process, the pre-selected temperature is greater than 280° C.

In some embodiments of the thermal conversion process, the pre-selected temperature is equal to 300° C.

In some embodiments of the thermal conversion process, the pre-selected temperature is greater than 300° C.

In some embodiments of the thermal conversion process, the pre-selected temperature is equal to 350° C.

In some embodiments of the thermal conversion process, the pre-selected temperature is greater than 350° C.

In some embodiments of the thermal conversion process, the pre-selected temperature is equal to 400° C.

In some embodiments of the thermal conversion process, the pre-selected temperature is greater than 400° C.

In some embodiments of the thermal conversion process, the pre-selected temperature is equal to 450° C.

In some embodiments of the thermal conversion process, the pre-selected temperature is greater than 450° C.

In some embodiments of the thermal conversion process, one or more of the pre-selected time intervals is 2 minutes.

In some embodiments of the thermal conversion process, one or more of the pre-selected time intervals is 5 minutes.

In some embodiments of the thermal conversion process, one or more of the pre-selected time intervals is 10 minutes.

In some embodiments of the thermal conversion process, one or more of the pre-selected time intervals is 15 minutes.

In some embodiments of the thermal conversion process, one or more of the pre-selected time intervals is 20 minutes.

In some embodiments of the thermal conversion process, one or more of the pre-selected time intervals is 25 minutes.

In some embodiments of the thermal conversion process, one or more of the pre-selected time intervals is 30 minutes.

In some embodiments of the thermal conversion process, one or more of the pre-selected time intervals is 35 minutes.

In some embodiments of the thermal conversion process, one or more of the pre-selected time intervals is 40 minutes.

In some embodiments of the thermal conversion process, one or more of the pre-selected time intervals is 45 minutes.

In some of the thermal conversion process, one or more of the pre-selected time intervals is 50 minutes.

In some embodiments of the thermal conversion process, one or more of the pre-selected time intervals is 55 minutes.

In some embodiments of the thermal conversion process, one or more of the pre-selected time intervals is 60 minutes.

In some embodiments of the thermal conversion process, one or more of the pre-selected time intervals is greater than 60 minutes.

In some embodiments of the thermal conversion process, one or more of the pre-selected time intervals is between 2 minutes and 60 minutes.

In some embodiments of the thermal conversion process, one or more of the pre-selected time intervals is between 2 minutes and 90 minutes.

In some embodiments of the thermal conversion process, one or more of the pre-selected time intervals is between 2 minutes and 120 minutes.

In some embodiments of the thermal conversion process, the thermal conversion process is run under an inert atmosphere, e.g., N₂ gas.

In some embodiments of the thermal conversion process, the thermal conversion process is run under ambient atmospheric conditions, i.e., no effort is made to exclude oxygen, water, or other naturally-occurring atmospheric components from the process.

In some embodiments of the thermal conversion process, the method for preparing a polyimide film comprises the following steps in order coating a solution containing a polyamic acid comprising one or more tetracarboxylic acid components and one or more diamine components onto a matrix; soft-baking the coated matrix; treating the soft-baked, coated matrix at a plurality of pre-selected temperatures for a plurality of pre-selected time intervals whereby the polyimide film exhibits properties that are satisfactory for use in electronics applications like those disclosed herein.

In some embodiments of the thermal conversion process, the method for preparing a polyimide film consists of the following steps in order coating a solution containing a polyamic acid comprising one or more tetracarboxylic acid components and one or more diamine components onto a matrix; soft-baking the coated matrix; treating the soft-baked, coated matrix at a plurality of pre-selected temperatures for a plurality of pre-selected time intervals whereby the polyimide film exhibits properties that are satisfactory for use in electronics applications like those disclosed herein.

In some embodiments of the thermal conversion process, the method for preparing a polyimide film consists essentially of the following steps in order coating a solution containing a polyamic acid comprising one or more tetracarboxylic acid components and one or more diamine components onto a matrix; soft-baking the coated matrix; treating the soft-baked, coated matrix at a plurality of pre-selected temperatures for a plurality of pre-selected time intervals whereby the polyimide film exhibits properties that are satisfactory for use in electronics applications like those disclosed herein.

Typically, the solutions/polyimides disclosed herein are coated/cured onto a supporting glass substrate to facilitate the processing through the rest of the display making process. At some point in the process as determined by the display maker, the polyimide coating is removed from the supporting glass substrate by a mechanical or laser lift off process. These processes separate the polyimide as a film with the deposited display layers from the glass and enable a flexible format. Often, this polyimide film with deposition layers is then bonded to a thicker, but still flexible, plastic film to provide support for subsequent fabrication of the display.

There are also provided modified-thermal conversion processes wherein conversion catalysts generally cause imidization reactions to run at lower temperatures than would be possible in the absence of such conversion catalysts.

In some embodiments, the solution containing the polyamic acid is converted into a polyimide film via a modified-thermal conversion process.

In some embodiments of the modified-thermal conversion process, the solution containing the polyamic acid further contains conversion catalysts.

In some embodiments of the modified-thermal conversion process, the solution containing the polyamic acid further contains conversion catalysts selected from the group consisting of tertiary amines.

In some embodiments of the modified-thermal conversion process, the solution containing the polyamic acid further contains conversion catalysts selected from the group consisting of tributylamine, dimethylethanolamine, isoquinoline, 1,2-dimethylimidazole, N-methylimidazole, 2-methylimidazole, 2-ethyl-4-imidazole, 3,5-dimethylpyridine, 3,4-dimethylpyrdine, 2,5-dimethylpyrdine, 5-methylbenzimidazole, and the like.

In some embodiments of the modified-thermal conversion process, the conversion catalyst is present at 5 weight percent or less of the solution containing the polyamic acid.

In some embodiments of the modified-thermal conversion process, the conversion catalyst is present at 3 weight percent or less of the solution containing the polyamic acid.

In some embodiments of the modified-thermal conversion process, the conversion catalyst is present at 1 weight percent or less of the solution containing the polyamic acid.

In some embodiments of the modified-thermal conversion process, the conversion catalyst is present at 1 weight percent of the solution containing the polyamic acid.

In some embodiments of the modified-thermal conversion process, the solution containing the polyamic acid further contains tributylamine as a conversion catalyst.

In some embodiments of the modified-thermal conversion process, the solution containing the polyamic acid further contains dimethylethanolamine as a conversion catalyst.

In some embodiments of the modified-thermal conversion process, the solution containing the polyamic acid further contains isoquinoline as a conversion catalyst.

In some embodiments of the modified-thermal conversion process, the solution containing the polyamic acid further contains 1,2-dimethylimidazole as a conversion catalyst.

In some embodiments of the modified-thermal conversion process, the solution containing the polyamic acid further contains 3,5-dimethylpyridine as a conversion catalyst.

In some embodiments of the modified-thermal conversion process, the solution containing the polyamic acid further contains 5-methylbenzimidazole as a conversion catalyst.

In some embodiments of the modified-thermal conversion process, the solution containing the polyamic acid further contains N-methylimidazole as a conversion catalyst.

In some embodiments of the modified-thermal conversion process, the solution containing the polyamic acid further contains 2-methylimidazole as a conversion catalyst.

In some embodiments of the modified-thermal conversion process, the solution containing the polyamic acid further contains 2-ethyl-4-imidazole as a conversion catalyst.

In some embodiments of the modified-thermal conversion process, the solution containing the polyamic acid further contains 3,4-dimethylpyridine as a conversion catalyst.

In some embodiments of the modified-thermal conversion process, the solution containing the polyamic acid further contains 2,5-dimethylpyrdine as a conversion catalyst.

In some embodiments of the modified-thermal conversion process, the solution containing the polyamic acid is coated onto the matrix such that the soft-baked thickness of the resulting film is less than 50 μm.

In some embodiments of the modified-thermal conversion process, the solution containing the polyamic acid is coated onto the matrix such that the soft-baked thickness of the resulting film is less than 40 μm.

In some embodiments of the modified-thermal conversion process, the solution containing the polyamic acid is coated onto the matrix such that the soft-baked thickness of the resulting film is less than 30 μm.

In some embodiments of the modified-thermal conversion process, the solution containing the polyamic acid is coated onto the matrix such that the soft-baked thickness of the resulting film is less than 20 μm.

In some embodiments of the modified-thermal conversion process, the solution containing the polyamic acid is coated onto the matrix such that the soft-baked thickness of the resulting film is between 10 μm and 20 μm.

In some embodiments of the modified-thermal conversion process, the solution containing the polyamic acid is coated onto the matrix such that the soft-baked thickness of the resulting film is between 15 μm and 20 μm.

In some embodiments of the modified-thermal conversion process, the solution containing the polyamic acid is coated onto the matrix such that the soft-baked thickness of the resulting film is 18 μm.

In some embodiments of the modified-thermal conversion process, the solution containing the polyamic acid is coated onto the matrix such that the soft-baked thickness of the resulting film is less than 10 μm.

In some embodiments of the modified-thermal conversion process, the coated matrix is soft baked on a hot plate in proximity mode wherein nitrogen gas is used to hold the coated matrix just above the hot plate.

In some embodiments of the modified-thermal conversion process, the coated matrix is soft baked on a hot plate in full-contact mode wherein the coated matrix is in direct contact with the hot plate surface.

In some embodiments of the modified-thermal conversion process, the coated matrix is soft baked on a hot plate using a combination of proximity and full-contact modes.

In some embodiments of the modified-thermal conversion process, the coated matrix is soft-baked using a hot plate set at 80° C.

In some embodiments of the modified-thermal conversion process, the coated matrix is soft-baked using a hot plate set at 90° C.

In some embodiments of the modified-thermal conversion process, the coated matrix is soft-baked using a hot plate set at 100° C.

In some embodiments of the modified-thermal conversion process, the coated matrix is soft-baked using a hot plate set at 110° C.

In some embodiments of the modified-thermal conversion process, the coated matrix is soft-baked using a hot plate set at 120° C.

In some embodiments of the modified-thermal conversion process, the coated matrix is soft-baked using a hot plate set at 130° C.

In some embodiments of the modified-thermal conversion process, the coated matrix is soft-baked using a hot plate set at 140° C.

In some embodiments of the modified-thermal conversion process, the coated matrix is soft-baked for a total time of more than 10 minutes.

In some embodiments of the modified-thermal conversion process, the coated matrix is soft-baked for a total time of less than 10 minutes.

In some embodiments of the modified-thermal conversion process, the coated matrix is soft-baked for a total time of less than 8 minutes.

In some embodiments of the modified-thermal conversion process, the coated matrix is soft-baked for a total time of less than 6 minutes.

In some embodiments of the modified-thermal conversion process, the coated matrix is soft-baked for a total time of 4 minutes.

In some embodiments of the modified-thermal conversion process, the coated matrix is soft-baked for a total time of less than 4 minutes.

In some embodiments of the modified-thermal conversion process, the coated matrix is soft-baked for a total time of less than 2 minutes.

In some embodiments of the modified-thermal conversion process, the soft-baked, coated matrix is subsequently cured at 2 pre-selected temperatures for 2 pre-selected time intervals, the latter of which may be the same or different.

In some embodiments of the modified-thermal conversion process, the soft-baked, coated matrix is subsequently cured at 3 pre-selected temperatures for 3 pre-selected time intervals, each of which of the latter of which may be the same or different.

In some embodiments of the modified-thermal conversion process, the soft-baked, coated matrix is subsequently cured at 4 pre-selected temperatures for 4 pre-selected time intervals, each of which of the latter of which may be the same or different.

In some embodiments of the modified-thermal conversion process, the soft-baked, coated matrix is subsequently cured at 5 pre-selected temperatures for 5 pre-selected time intervals, each of which of the latter of which may be the same or different.

In some embodiments of the modified-thermal conversion process, the soft-baked, coated matrix is subsequently cured at 6 pre-selected temperatures for 6 pre-selected time intervals, each of which of the latter of which may be the same or different.

In some embodiments of the modified-thermal conversion process, the soft-baked, coated matrix is subsequently cured at 7 pre-selected temperatures for 7 pre-selected time intervals, each of which of the latter of which may be the same or different.

In some embodiments of the modified-thermal conversion process the soft-baked, coated matrix is subsequently cured at 8 pre-selected temperatures for 8 pre-selected time intervals, each of which of the latter of which may be the same or different.

In some embodiments of the modified-thermal conversion process, the soft-baked, coated matrix is subsequently cured at 9 pre-selected temperatures for 9 pre-selected time intervals, each of which of the latter of which may be the same or different.

In some embodiments of the modified-thermal conversion process, the soft-baked, coated matrix is subsequently cured at 10 pre-selected temperatures for 10 pre-selected time intervals, each of which of the latter of which may be the same or different.

In some embodiments of the modified-thermal conversion process, the pre-selected temperature is greater than 80° C.

In some embodiments of the modified-thermal conversion process, the pre-selected temperature is equal to 100° C.

In some embodiments of the modified-thermal conversion process, the pre-selected temperature is greater than 100° C.

In some embodiments of the modified-thermal conversion process, the pre-selected temperature is equal to 150° C.

In some embodiments of the modified-thermal conversion process, the pre-selected temperature is greater than 150° C.

In some embodiments of the modified-thermal conversion process, the pre-selected temperature is equal to 200° C.

In some embodiments of the modified-thermal conversion process, the pre-selected temperature is greater than 200° C.

In some embodiments of the modified-thermal conversion process, the pre-selected temperature is equal to 220° C.

In some embodiments of the modified-thermal conversion process, the pre-selected temperature is greater than 220° C.

In some embodiments of the modified-thermal conversion process, the pre-selected temperature is equal to 230° C.

In some embodiments of the modified-thermal conversion process, the pre-selected temperature is greater than 230° C.

In some embodiments of the modified-thermal conversion process, the pre-selected temperature is equal to 240° C.

In some embodiments of the modified-thermal conversion process, the pre-selected temperature is greater than 240° C.

In some embodiments of the modified-thermal conversion process, the pre-selected temperature is equal to 250° C.

In some embodiments of the modified-thermal conversion process, the pre-selected temperature is greater than 250° C.

In some embodiments of the modified-thermal conversion process, the pre-selected temperature is equal to 260° C.

In some embodiments of the modified-thermal conversion process, the pre-selected temperature is greater than 260° C.

In some embodiments of the modified-thermal conversion process, the pre-selected temperature is equal to 270° C.

In some embodiments of the modified-thermal conversion process, the pre-selected temperature is greater than 270° C.

In some embodiments of the modified-thermal conversion process, the pre-selected temperature is equal to 280° C.

In some embodiments of the modified-thermal conversion process, the pre-selected temperature is greater than 280° C.

In some embodiments of the modified-thermal conversion process, the pre-selected temperature is equal to 290° C.

In some embodiments of the modified-thermal conversion process, the pre-selected temperature is greater than 290° C.

In some embodiments of the modified-thermal conversion process, the pre-selected temperature is equal to 300° C.

In some embodiments of the modified-thermal conversion process, the pre-selected temperature is less than 300° C.

In some embodiments of the modified-thermal conversion process, the pre-selected temperature is less than 290° C.

In some embodiments of the modified-thermal conversion process, the pre-selected temperature is less than 280° C.

In some embodiments of the modified-thermal conversion process, the pre-selected temperature is less than 270° C.

In some embodiments of the modified-thermal conversion process, the pre-selected temperature is less than 260° C.

In some embodiments of the modified-thermal conversion process, the pre-selected temperature is less than 250° C.

In some embodiments of the modified-thermal conversion process, one or more of the pre-selected time intervals is 2 minutes.

In some embodiments of the modified-thermal conversion process, one or more of the pre-selected time intervals is 5 minutes.

In some embodiments of the modified-thermal conversion process, one or more of the pre-selected time intervals is 10 minutes.

In some embodiments of the modified-conversion process, one or more of the pre-selected time intervals is 15 minutes.

In some embodiments of the modified-thermal conversion process, one or more of the pre-selected time intervals is 20 minutes.

In some embodiments of the modified-thermal conversion process, one or more of the pre-selected time intervals is 25 minutes.

In some embodiments of the modified-thermal conversion process, one or more of the pre-selected time intervals is 30 minutes.

In some embodiments of the modified-thermal conversion process, one or more of the pre-selected time intervals is 35 minutes.

In some embodiments of the modified-thermal conversion process, one or more of the pre-selected time intervals is 40 minutes.

In some embodiments of the modified-thermal conversion process, one or more of the pre-selected time intervals is 45 minutes.

In some embodiments of the modified-thermal conversion process, one or more of the pre-selected time intervals is 50 minutes.

In some embodiments of the modified-thermal conversion process, one or more of the pre-selected time intervals is 55 minutes.

In some embodiments of the modified-thermal conversion process, one or more of the pre-selected time intervals is 60 minutes.

In some embodiments of the modified-thermal conversion process, one or more of the pre-selected time intervals is greater than 60 minutes.

In some embodiments of the modified-thermal conversion process, one or more of the pre-selected time intervals is between 2 minutes and 60 minutes.

In some embodiments of the modified-thermal conversion process, one or more of the pre-selected time intervals is between 2 minutes and 90 minutes.

In some embodiments of the modified-thermal conversion process, one or more of the pre-selected time intervals is between 2 minutes and 120 minutes.

### 4. Flexible Replacement for Glass in an Electronic Device

The polyimide films disclosed herein can be suitable for use in a number of layers in electronic display devices such as OLED and LCD Displays. Nonlimiting examples of such layers include device substrates, touch panels, substrates for color filter sheets, cover films, and others. The particular materials' properties requirements for each application are unique and may be addressed by appropriate composition(s) and processing condition(s) for the polyimide films disclosed herein.

In some embodiments, the flexible replacement for glass in an electronic device is a polyimide film having the repeat unit of Formula I

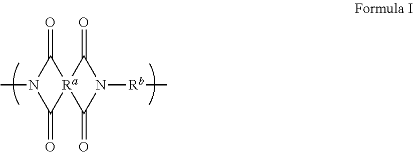

wherein:
R^{a} is a quadrivalent organic group derived from one or more acid dianhydrides selected from the group consisting of bent dianhydrides and aromatic dianhydrides containing one or more aromatic tetracarboxylic acid components comprising —O—, —CO—, —NHCO—, —S—, —SO₂—, —CO—O—, or —CR₂— chains, or a direct chemical bond between aromatic rings;
   and
R^{b} is a divalent organic group derived from one or more diamines selected from the group consisting of bent diamines and aromatic diamines comprising —C—, —CO—, —NHCO—, —S—, —SO₂—, —CO—C—, or —CR₂— chains, or a direct chemical bond between aromatic rings;
   wherein:

R is the same or different at each occurrence and is selected from the group consisting of H, F, alkyl, and fluoroalkyl; such that:
the in-plane coefficient of thermal expansion (CTE) is less than 50 ppm/° C. between 50° C. and 250° C.;
the glass transition temperature (T_{g}) is greater than 250° C. for a polyimide film cured at 260° C. in air;
the 1% TGA weight loss temperature is greater than 350° C.;
the tensile modulus is between 1.5 GPa and 5.0 GPa;
the elongation to break is greater than 10%;
the optical retardation is less than 20 nm for a 10-μm film;
the birefringence at 633 nm is less than 0.007;
the haze is less than 1.0%;
the b* is less than 5;
the transmittance at 400 nm is greater than 45%;
the transmittance at 430 nm is greater than 80%;
the transmittance at 450 nm is greater than 85%;
the transmittance at 550 nm is greater than 88%; and
the transmittance at 750 nm is greater than 90%.

In some embodiments, the flexible replacement for glass in an electronic device is a polyimide film having the repeat unit of Formula I and the composition disclosed herein.

### 5. The Electronic Device

Organic electronic devices that may benefit from having one or more layers including at least one compound as described herein include, but are not limited to, (1) devices that convert electrical energy into radiation (e.g., a light-emitting diode, light emitting diode display, lighting device, luminaire, or diode laser), (2) devices that detect signals through electronics processes (e.g., photodetectors, photoconductive cells, photoresistors, photoswitches, phototransistors, phototubes, IR detectors, biosensors), (3) devices that convert radiation into electrical energy, (e.g., a photovoltaic device or solar cell), (4) devices that convert light of one wavelength to light of a longer wavelength, (e.g., a down-converting phosphor device); and (5) devices that include one or more electronic components that include one or more organic semi-conductor layers (e.g., a transistor or diode). Other uses for the compositions according to the present invention include coating materials for memory storage devices, antistatic films, biosensors, electrochromic devices, solid electrolyte capacitors, energy storage devices such as a rechargeable battery, and electromagnetic shielding applications.

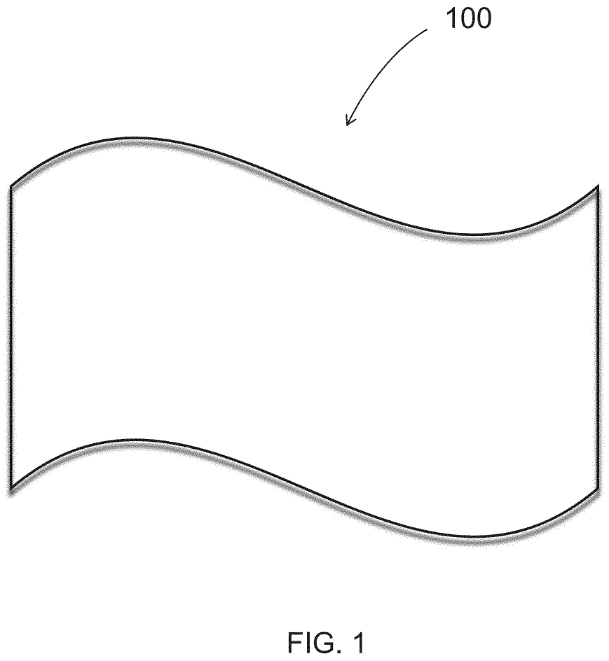

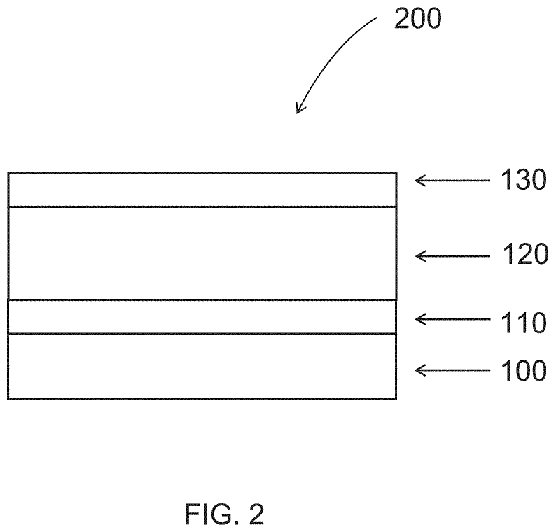

One illustration of a polyimide film that can act as a flexible replacement for glass as described herein is shown in FIG. 1. The flexible film 100 can have the properties as described in the embodiments of this disclosure. In some embodiments, the polyimide film that can act as a flexible replacement for glass is included in an electronic device. FIG. 2 illustrates the case when the electronic device 200 is an organic electronic device. The device 200 has a substrate 100, an anode layer 110 and a second electrical contact layer, a cathode layer 130, and a photoactive layer 120 between them. Additional layers may optionally be present. Adjacent to the anode may be a hole injection layer (not shown), sometimes referred to as a buffer layer. Adjacent to the hole injection layer may be a hole transport layer (not shown), including hole transport material. Adjacent to the cathode may be an electron transport layer (not shown), including an electron transport material. As an option, devices may use one or more additional hole injection or hole transport layers (not shown) next to the anode 110 and/or one or more additional electron injection or electron transport layers (not shown) next to the cathode 130. Layers between 110 and 130 are individually and collectively referred to as the organic active layers. Additional layers that may or may not be present include color filters, touch panels, and/or cover sheets. One or more of these layers, in addition to the substrate 100, may also be made from the polyimide films disclosed herein.

The different layers will be discussed further herein with reference to FIG. 2. However, the discussion applies to other configurations as well.

In some embodiments, the different layers have the following range of thicknesses: substrate 100, 5-100 microns, anode 110, 500-5000 Å, in some embodiments, 1000-2000 Å; hole injection layer (not shown), 50-2000 Å, in some embodiments, 200-1000 Å; hole transport layer (not shown), 50-3000 Å, in some embodiments, 200-2000 Å; photoactive layer 120, 10-2000 Å, in some embodiments, 100-1000 Å; electron transport layer (not shown), 50-2000 Å, in some embodiments, 100-1000 Å; cathode 130, 200-10000 Å, in some embodiments, 300-5000 Å. The desired ratio of layer thicknesses will depend on the exact nature of the materials used.

In some embodiments, the organic electronic device (OLED) contains a flexible replacement for glass as disclosed herein.

In some embodiments, an organic electronic device includes a substrate, an anode, a cathode, and a photoactive layer therebetween, and further includes one or more additional organic active layers. In some embodiments, the additional organic active layer is a hole transport layer. In some embodiments, the additional organic active layer is an electron transport layer. In some embodiments, the additional organic layers are both hole transport and electron transport layers.

The anode 110 is an electrode that is particularly efficient for injecting positive charge carriers. It can be made of, for example materials containing a metal, mixed metal, alloy, metal oxide or mixed-metal oxide, or it can be a conducting polymer, and mixtures thereof. Suitable metals include the Group 11 metals, the metals in Groups 4, 5, and 6, and the Group 8-10 transition metals. If the anode is to be light-transmitting, mixed-metal oxides of Groups 12, 13 and 14 metals, such as indium-tin-oxide, are generally used. The anode may also include an organic material such as polyaniline as described in “Flexible light-emitting diodes made from soluble conducting polymer,” Nature vol. 357, pp 477 479 (11 Jun. 1992). At least one of the anode and cathode should be at least partially transparent to allow the generated light to be observed.

Optional hole injection layers can include hole injection materials. The term “hole injection layer” or “hole injection material” is intended to mean electrically conductive or semiconductive materials and may have one or more functions in an organic electronic device, including but not limited to, planarization of the underlying layer, charge transport and/or charge injection properties, scavenging of impurities such as oxygen or metal ions, and other aspects to facilitate or to improve the performance of the organic electronic device. Hole injection materials may be polymers, oligomers, or small molecules, and may be in the form of solutions, dispersions, suspensions, emulsions, colloidal mixtures, or other compositions.

The hole injection layer can be formed with polymeric materials, such as polyaniline (PANI) or polyethylenedioxythiophene (PEDOT), which are often doped with protonic acids. The protonic acids can be, for example, poly(styrenesulfonic acid), poly(2-acrylamido-2-methyl-1-propanesulfonic acid), and the like. The hole injection layer 120 can include charge transfer compounds, and the like, such as copper phthalocyanine and the tetrathiafulvalene-tetracyanoquinodimethane system (TTF-TCNQ). In some embodiments, the hole injection layer 120 is made from a dispersion of a conducting polymer and a colloid-forming polymeric acid. Such materials have been described in, for example, published U.S. patent applications 2004-0102577, 2004-0127637, and 2005-0205860.

Other layers can include hole transport materials. Examples of hole transport materials for the hole transport layer have been summarized for example, in Kirk-Othmer Encyclopedia of Chemical Technology, Fourth Edition, Vol. 18, p. 837-860, 1996, by Y. Wang. Both hole transporting small molecules and polymers can be used. Commonly used hole transporting molecules include, but are not limited to: 4,4′,4″-tris(N,N-diphenyl-amino)-triphenylamine (TDATA); 4,4′,4″-tris(N-3-methylphenyl-N-phenyl-amino)-triphenylamine (MTDATA); N,N′-diphenyl-N,N′-bis(3-methylphenyl)-[1,1′-biphenyl]-4,4′-diamine (TPD); 4, 4′-bis(carbazol-9-yl)biphenyl (CBP); 1,3-bis(carbazol-9-yl)benzene (mCP); 1,1-bis[(di-4-tolylamino) phenyl]cyclohexane (TAPC); N,N′-bis(4-methylphenyl)-N,N′-bis(4-ethylphenyl)-[1,1′-(3,3′-dimethyl)biphenyl]-4,4′-diamine (ETPD); tetrakis-(3-methylphenyl)-N,N,N′,N′-2,5-phenylenediamine (PDA); α-phenyl-4-N,N-diphenylaminostyrene (TPS); p-(diethylamino)benzaldehyde diphenylhydrazone (DEH); triphenylamine (TPA); bis[4-(N,N-diethylamino)-2-methylphenyl](4-methylphenyl)methane (MPMP); 1-phenyl-3-[p-(diethylamino)styryl]-5-[p-(diethylamino)phenyl] pyrazoline (PPR or DEASP); 1,2-trans-bis(9H-carbazol-9-yl)cyclobutane (DCZB); N,N,N′,N′-tetrakis(4-methylphenyl)-(1,1′-biphenyl)-4,4′-diamine (TTB); N,N′-bis(naphthalen-1-yl)-N,N′-bis-(phenyl)benzidine (a-NPB); and porphyrinic compounds, such as copper phthalocyanine. Commonly used hole transporting polymers include, but are not limited to, polyvinylcarbazole, (phenylmethyl)polysilane, poly(dioxythiophenes), polyanilines, and polypyrroles. It is also possible to obtain hole transporting polymers by doping hole transporting molecules such as those mentioned above into polymers such as polystyrene and polycarbonate. In some cases, triarylamine polymers are used, especially triarylamine-fluorene copolymers. In some cases, the polymers and copolymers are crosslinkable. Examples of crosslinkable hole transport polymers can be found in, for example, published US patent application 2005-0184287 and published PCT application WO 2005/052027. In some embodiments, the hole transport layer is doped with a p-dopant, such as tetrafluorotetracyanoquinodimethane and perylene-3,4,9,10-tetracarboxylic-3,4,9,10-dianhydride.

Depending upon the application of the device, the photoactive layer 120 can be a light-emitting layer that is activated by an applied voltage (such as in a light-emitting diode or light-emitting electrochemical cell), a layer of material that absorbs light and emits light having a longer wavelength (such as in a down-converting phosphor device), or a layer of material that responds to radiant energy and generates a signal with or without an applied bias voltage (such as in a photodetector or photovoltaic device).

In some embodiments, the photoactive layer includes a compound comprising an emissive compound having as a photoactive material. In some embodiments, the photoactive layer further comprises a host material. Examples of host materials include, but are not limited to, chrysenes, phenanthrenes, triphenylenes, phenanthrolines, naphthalenes, anthracenes, quinolines, isoquinolines, quinoxalines, phenylpyridines, carbazoles, indolocarbazoles, furans, benzofurans, dibenzofurans, benzodifurans, and metal quinolinate complexes. In some embodiments, the host materials are deuterated.

In some embodiments, the photoactive layer comprises (a) a dopant capable of electroluminescence having an emission maximum between 380 and 750 nm, (b) a first host compound, and (c) a second host compound. Suitable second host compounds are described above.

In some embodiments, the photoactive layer includes only (a) a dopant capable of electroluminescence having an emission maximum between 380 and 750 nm, (b) a first host compound, and (c) a second host compound, where additional materials that would materially alter the principle of operation or the distinguishing characteristics of the layer are not present.

In some embodiments, the first host is present in higher concentration than the second host, based on weight in the photoactive layer.

In some embodiments, the weight ratio of first host to second host in the photoactive layer is in the range of 10:1 to 1:10. In some embodiments, the weight ratio is in the range of 6:1 to 1:6; in some embodiments, 5:1 to 1:2; in some embodiments, 3:1 to 1:1.

In some embodiments, the weight ratio of dopant to the total host is in the range of 1:99 to 20:80; in some embodiments, 5:95 to 15:85.

In some embodiments, the photoactive layer comprises (a) a red light-emitting dopant, (b) a first host compound, and (c) a second host compound.

In some embodiments, the photoactive layer comprises (a) a green light-emitting dopant, (b) a first host compound, and (c) a second host compound.

In some embodiments, the photoactive layer comprises (a) a yellow light-emitting dopant, (b) a first host compound, and (c) a second host compound.

Optional layers can function both to facilitate electron transport, and also serve as a confinement layer to prevent quenching of the exciton at layer interfaces. Preferably, this layer promotes electron mobility and reduces exciton quenching.

In some embodiments, such layers include other electron transport materials. Examples of electron transport materials which can be used in the optional electron transport layer, include metal chelated oxinoid compounds, including metal quinolate derivatives such as tris(8-hydroxyquinolato)aluminum (AlQ), bis(2-methyl-8-quinolinolato)(p-phenylphenolato) aluminum (BAlq), tetrakis-(8-hydroxyquinolato)hafnium (HfQ) and tetrakis-(8-hydroxyquinolato)zirconium (ZrQ); and azole compounds such as 2- (4-biphenylyl)-5-(4-t-butylphenyl)-1,3,4-oxadiazole (PBD), 3-(4-biphenylyl)-4-phenyl-5-(4-t-butylphenyl)-1,2,4-triazole (TAZ), and 1,3,5-tri(phenyl-2-benzimidazole)benzene (TPBI); quinoxaline derivatives such as 2,3-bis(4-fluorophenyl)quinoxaline; phenanthrolines such as 4,7-diphenyl-1,10-phenanthroline (DPA) and 2,9-dimethyl-4,7-diphenyl-1,10-phenanthroline (DDPA); triazines; fullerenes; and mixtures thereof. In some embodiments, the electron transport material is selected from the group consisting of metal quinolates and phenanthroline derivatives. In some embodiments, the electron transport layer further includes an n-dopant. N-dopant materials are well known. The n-dopants include, but are not limited to, Group 1 and 2 metals; Group 1 and 2 metal salts, such as LiF, CsF, and Cs₂CO₃; Group 1 and 2 metal organic compounds, such as Li quinolate; and molecular n-dopants, such as leuco dyes, metal complexes, such as W₂(hpp)₄ where hpp=1,3,4,6,7,8-hexahydro-2H-pyrimido-[1,2-a]-pydmidine and cobaltocene, tetrathianaphthacene, bis(ethylenedithio)tetrathiafulvalene, heterocyclic radicals or diradicals, and the dimers, oligomers, polymers, dispiro compounds and polycycles of heterocyclic radical or diradicals.

An optional electron injection layer may be deposited over the electron transport layer. Examples of electron injection materials include, but are not limited to, Li-containing organometallic compounds, LiF, Li₂O, Li quinolate, Cs-containing organometallic compounds, CsF, Cs₂O, and Cs₂CO₃. This layer may react with the underlying electron transport layer, the overlying cathode, or both. When an electron injection layer is present, the amount of material deposited is generally in the range of 1-100 Å, in some embodiments 1-10 Å.

The cathode 130 is an electrode that is particularly efficient for injecting electrons or negative charge carriers. The cathode can be any metal or nonmetal having a lower work function than the anode. Materials for the cathode can be selected from alkali metals of Group 1 (e.g., Li, Cs), the Group 2 (alkaline earth) metals, the Group 12 metals, including the rare earth elements and lanthanides, and the actinides. Materials such as aluminum, indium, calcium, barium, samarium and magnesium, as well as combinations, can be used.

It is known to have other layers in organic electronic devices. For example, there can be layers (not shown) between the anode 110 and hole injection layer (not shown) to control the amount of positive charge injected and/or to provide band-gap matching of the layers, or to function as a protective layer. Layers that are known in the art can be used, such as copper phthalocyanine, silicon oxy-nitride, fluorocarbons, silanes, or an ultra-thin layer of a metal, such as Pt. Alternatively, some or all of anode layer 110, active layer 120, or cathode layer 130, can be surface-treated to increase charge carrier transport efficiency. The choice of materials for each of the component layers is preferably determined by balancing the positive and negative charges in the emitter layer to provide a device with high electroluminescence efficiency.

It is understood that each functional layer can be made up of more than one layer.

The device layers can generally be formed by any deposition technique, or combinations of techniques, including vapor deposition, liquid deposition, and thermal transfer. Substrates such as glass, plastics, and metals can be used. Conventional vapor deposition techniques can be used, such as thermal evaporation, chemical vapor deposition, and the like. The organic layers can be applied from solutions or dispersions in suitable solvents, using conventional coating or printing techniques, including but not limited to spin-coating, dip-coating, roll-to-roll techniques, ink-jet printing, continuous nozzle printing, screen-printing, gravure printing and the like.

For liquid deposition methods, a suitable solvent for a particular compound or related class of compounds can be readily determined by one skilled in the art. For some applications, it is desirable that the compounds be dissolved in non-aqueous solvents. Such non-aqueous solvents can be relatively polar, such as C₁ to C₂₀ alcohols, ethers, and acid esters, or can be relatively non-polar such as C₁ to C₁₂ alkanes or aromatics such as toluene, xylenes, trifluorotoluene and the like. Other suitable liquids for use in making the liquid composition, either as a solution or dispersion as described herein, including the new compounds, includes, but not limited to, chlorinated hydrocarbons (such as methylene chloride, chloroform, chlorobenzene), aromatic hydrocarbons (such as substituted and non-substituted toluenes and xylenes), including triflurotoluene), polar solvents (such as tetrahydrofuran (THP), N-methyl pyrrolidone) esters (such as ethylacetate) alcohols (isopropanol), ketones (cyclopentatone) and mixtures thereof. Suitable solvents for electroluminescent materials have been described in, for example, published PCT application WO 2007/145979.

In some embodiments, the device is fabricated by liquid deposition of the hole injection layer, the hole transport layer, and the photoactive layer, and by vapor deposition of the anode, the electron transport layer, an electron injection layer and the cathode onto the flexible substrate.

It is understood that the efficiency of devices can be improved by optimizing the other layers in the device. For example, more efficient cathodes such as Ca, Ba or LiF can be used. Shaped substrates and novel hole transport materials that result in a reduction in operating voltage or increase quantum efficiency are also applicable. Additional layers can also be added to tailor the energy levels of the various layers and facilitate electroluminescence.

In some embodiments, the device has the following structure, in order substrate, anode, hole injection layer, hole transport layer, photoactive layer, electron transport layer, electron injection layer, cathode.

Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety.

### Examples

The concepts described herein will be further illustrated in the following examples, which do not limit the scope of the invention described in the claims.

Specific film properties will be determined by the compositions and imidization processes used in each case.

In some embodiments, the polyimide film as disclosed herein has a T_{g} that is greater than 250° C. for a film cured at 260° C. in air.

In some embodiments, the polyimide film as disclosed herein has an in-plane coefficient of thermal expansion (CTE) that is less than 70 ppm/° C. between 50° C. and 250° C.

In some embodiments, the polyimide film as disclosed herein has an optical retardation measured at 550 nm that is less than about 20 nm fora 10-μm film.

In some embodiments, the polyimide film as disclosed herein has a b* that is less than 4.

Representative sample compositions include:

| Dianhyd//Diamine | Ratios |
|---|---|
| ODPA//HFBAPP | 100//100 |
| ODPA//TFMB/APB133 | 100//75/25 |
| ODPA//TFMB/APB133 | 100//90/10 |
| ODPA/a-BPDA//22TFMB/APB133 | 50/50//85/15 |
| ODPA//APB133/TFMB | 100//85/15 |
| ODPA//APB133/TFMB | 100//20/80 |
| PMDA/ODPA//bisp/TFMB | 65/35//35/65 |
| ODPA//3,4ODA | 100//100 |
| ODPA//3,4ODA/MPD | 100//40/60 |
| ODPA//3,4ODA/TFMB | 100//50/50 |
| ODPA//3,3DDS/TFMB | 100//80/20 |
| ODPA//BisP/MPD (90:10) | 100//90/10 |
| ODPA//TFMB/APB-133 | 100//90/10 |
| ODPA//Bis P | 100//100 |
| ODPA/BPDA//Bis P | 90/10//100 |
| ODPA//TFMB/APB133/Bis P | 100//80/10/10 |
| ODPA//Bis P/MPD | 100//80/20 |
| ODPA/PMDA//TFMB | 60/40//100 |
| ODPA/PMDA//TFMB | 60/40//100 |
| ODPA/PMDA//TFMB | 65/35//100 |
| ODPA/PMDA//TFMB | 65/35//100 |
| ODPA//TFMB | 100//100 |
| ODPA//TFMB | 100//100 |
| BPDA/a-BPDA//TFMB/APB133 | 75/25//75/25 |
| ODPA/a-BPDA//TFMB/APB133 | 50/50//85/15 |

### Example A—Preparation of Polyamic Acid Copolymer of ODPA//TFMB/APB-133 (100//80/20) in DMAC

Into a 1-liter reaction flask equipped with a nitrogen inlet and outlet, mechanical stirrer, and thermocouple were charged 24.72 g of trifluoromethyl benzidine (TFMB) and 200 g of dimethylacetamide (DMAC). The mixture was agitated under nitrogen at room temperature for about 30 minutes to dissolve the TFMB. Afterwards, 5.64 g of 1,3,3-aminophenoxy benzene (APB-133) was added with 50 g DMAC. After the diamine dissolved, 29.64 g oxydiphthalic anhydride (ODPA) was added to the reaction with stirring along with 90 g DMAC. The addition rate of the dianhydrides was controlled, so as to keep the maximum reaction temperature <40° C. The dianhydride dissolved and reacted and the polyamic acid (PAA) solution was stirred for −24 hr. After this, ODPA was added in 0.10 g increments to raise the molecular weight of the polymer and viscosity of the polymer solution in a controlled manner. Brookfield cone and plate viscometry was used to monitor the solution viscosity by removing small samples from the reaction flask for testing. A total of 0.20 g of ODPA was added.

The reaction proceeded for an additional 72 hours at room temperature under gentle agitation to allow for polymer equilibration. Final viscosity of the polymer solution was 10467 cps at 25° C. The contents of the flask were poured into a 1-liter HDPE bottle, tightly capped, and stored in a refrigerator for later use.

### Example 1—Spin Coating and Imidization of Polyamic Acid Solution to Polyimide Coating

A portion of the polyamic acid solution from Example A was pressure filtered through a Whatman PolyCap HD 0.45 μm absolute filter into a EFD Nordsen dispensing syringe barrel. This syringe barrel was attached to an EFD Nordsen dispensing unit to apply several ml of polymer solution onto, and spin coat, a 6″ silicon wafer. The spin speed was varied into order to obtain the desired soft-baked thickness of about 18 μm. Soft-baking was accomplished after coating by placing the coated wafer onto a hot plate set at 110° C., first in proximity mode (nitrogen flow to hold wafer just off the surface of the hot plate) for 1 minute, followed by direct contact with the hot plate surface for 3 minutes. The thickness of the soft-baked film was measured on a Tencor profilometer but removing sections of the coating from the wafer and then measuring the difference between coated and uncoated areas of the wafer. The spin coating conditions were varied as necessary to obtain the desired −15 μm uniform coating across the wafer surface.

Afterwards, the spin coating conditions were determined, several wafers were coated, soft-baked, and then these coated wafers were placed in a convection oven. After closing the oven door, the oven was ramped to 100 C at 2.5° C./min and held there for about 30 min, then the temperature was ramped at 4° C./min to 260 30° C. and held there for 60 min. The curing profile was conducted under an air atmosphere. After this, the heating was stopped and the temperature allowed to return slowly to ambient temperature (no external cooling). Afterward, the wafers were removed from the furnace and the coatings were removed from the wafers by scoring the coating around the edge of the wafer with a knife and then soaking the wafers in water for at least several hours to lift the coating off the wafer. The resulting polyimide films allowed to dry and then subject to various property measurements. The polyimide film exhibited a b* of 2.1 and an optical retardation of 35 nm.

### Additional Synthesis Examples and Comparative Examples

### Example B—Preparation of Polyamic Acid Copolymer of ODPA//Bis-P/TFMB 100//90/10 in NMP

This solution containing polyamic acid ODPA//Bis-P/TFMB 100//90/10 was prepared in NMP in an analogous manner to that done in Example A above, except that the specific dianhydride and diamines, and their respective relative amounts, were appropriate for this target composition. The prepared solution was poured into a 2-liter HDPE bottle, tightly capped, and stored in a refrigerator for later use.

### Example 2—Spin Coating and Imidization Under Ambient Atmospheric Conditions of Polyamic Acid Solution to ODPA//Bis-PTFMB 100//90/10 Polyimide Coating

In a manner analogous to that described above in Example 1, the solution containing the polyamic acid copolymer prepared in Example B was filtered, coated onto a 6″ silicon wafer, soft-baked, and imidized. Maximum cure temperature of the imidization temperature profile was 260° C. and the process was run under ambient atmospheric conditions. The heating was then stopped and the temperature allowed to return slowly to ambient temperature (no external cooling). Afterward, the wafers were removed from the furnace and the coatings were removed from the wafers by scoring the coating around the edge of the wafer with a knife and then soaking the wafers in water for at least several hours to lift the coating off the wafer. The resulting polyimide films allowed to dry and then subject to various property measurements. For example, a Hunter Lab spectrophotometer was used to measure b* and yellow index along with % transmittance (% T) over the wavelength range 350 nm-780 nm. Optical birefringence is measured with a Metricon instrument with a 543-nm laser. Optical Retardation is measured with an Axoscan instrument at 550 nm. Thermal measurements on films were made using a combination of thermogravimetric analysis and thermomechanical analysis as appropriate for the specific parameters reported herein. Mechanical properties were measured using equipment from Instron. Property measurements for this film are presented in Table 1.

### Example 3—Spin Coating and Imidization in an Inert Atmosphere of Polyamic Acid Solution to ODPA//Bis-P/TFMB 100//90/10 Polyimide Coating

In a manner analogous to that described above in Example 1, the solution containing the polyamic acid copolymer prepared in Example B was filtered, coated onto a 6″ silicon wafer, soft-baked, and imidized. Maximum cure temperature of the imidization temperature profile was 260° C. and the process was run in a nitrogen gas atmosphere. The heating was then stopped and the temperature allowed to return slowly to ambient temperature (no external cooling). Afterward, the wafers were removed from the furnace and the coatings were removed from the wafers by scoring the coating around the edge of the wafer with a knife and then soaking the wafers in water for at least several hours to lift the coating off the wafer. The resulting polyimide films allowed to dry and then subject to various property measurements. For example, a Hunter Lab spectrophotometer was used to measure b* and yellow index along with % transmittance (% T) over the wavelength range 350 nm-780 nm. Optical birefringence is measured with a Metricon instrument with a 543-nm laser. Optical Retardation is measured with an Axoscan instrument at 550 nm. Thermal measurements on films were made using a combination of thermogravimetric analysis and thermomechanical analysis as appropriate for the specific parameters reported herein. Mechanical properties were measured using equipment from Instron. Property measurements for this film are presented in Table 1.

TABLE 1
Properties of ODPA//Bis-P/TFMB 100//90/10
Films Imidized in Air and Nitrogen.

| | | Example 2 | Example 3 |
|---|---|---|---|
| Film | Composition | ODPA//Bis-P/ | ODPA//Bis-P/ |
| Properties | (mole %) | TFMB | TFMB |
| | | 100//90/10 | 100//90/10 |
| | Cure | 260/AIR | 260/N₂ |
| | Temp (° C.)/ | | |
| | Atmosphere | | |
| | Film | 10.5 | 13.2 |
| | Thickness | | |
| | (μm) | | |
| Thermal | T_{g} (° C.) | 259 | 261 |
| Properties | CTE | 66.14 | 66.90 |
| | (ppm/° C.) | | |
| | 1.0% TGA WT | 459.4 | 469.9 |
| | LOSS (° C.) | | |
| Mechan- | Tensile | 3.05 | 3.18 |
| ical | Modulus | | |
| Properties | (GPa) | | |
| | Tensile | 98.89 | 102.69 |
| | Strength | | |
| | (MPa) | | |
| | Elongation to | 61.53 | 64.52 |
| | Break (%) | | |
| Optical | Yl | 3.77 | 4.39 |
| Properties | b* | 2.51 | 2.64 |
| | R_{TH} at 550 nm | 18 | 19.70 |
| | (nm) | | |

Note that thermal, mechanical, and optical properties all compare favorably for films imidized in air and nitrogen. Significantly, the color properties of the films prepared under ambient atmosphere can be superior to those for the N₂ case for many of the applications disclosed herein. Both films have R_{TH} at 550 nm that are less than nm.

### Examples C, D, E, F, G, H, and Comparative Example A—Preparation of Polyamic Acid Copolymers in NMP with Compositions

Example C: ODPA//3,3′DDS 100/1100

Example D: ODPA//Bis-P 100//100

Example E: ODPA//BIS-P/MPD 100//90/10

Example F: ODPA/6FDA//Bis-P 90/10/1100

Example G: ODPA/6FDA/Bis-PITFMB 90/10//90/10

Example H: ODPA/a-BPDA//Bis-P/TFMB 60/40//90/10

Comparative Example A: BPDA//Bis-P 100//100

Solutions containing polyamic acid of the above compositions were prepared in NMP using analogous steps to those disclosed for Examples A and B above, except that specific dianhydrides and diamines, and their respective relative amounts, were appropriate for these target compositions. The prepared solutions were poured into a 2-liter HDPE bottles, tightly capped, and stored in a refrigerator for later use.

### Examples 4, 5, 6, 7, 8, 9, and Comparative Example 1—Spin Coating and Imidization of Polyamic Acid Solutions with Compositions

Example 4: ODPA//3,3′DDS 100//100

Example 5: ODPA/Bis-P 100//100

Example 6: ODPA//BIS-P/MPD 100//90/10

Example 7: ODPA/6FDA//Bis-P 90/10//100

Example 8: ODPA/6FDA//Bis-P/TFMB 90/10//90/10

Example 9: ODPA/a-BPDA/Bis-P/TFMB 60/40//90/10

Comparative Example 1: BPDA//Bis-P 100//100

In a manner analogous to that described above in Examples 1-3, the solution containing the polyamic acid copolymer prepared in Examples C-H and Comparative Example A were filtered, coated onto a 6″ silicon wafer, soft-baked, and imidized. Maximum cure temperature of the imidization temperature profile in all cases was 260° C. and the process was run either under ambient atmospheric conditions or in a nitrogen gas atmosphere (see Table 2a and Table 2b). The heating was then stopped and the temperature allowed to return slowly to ambient temperature (no external cooling). Afterward, the wafers were removed from the furnace and the coatings were removed from the wafers by scoring the coating around the edge of the wafer with a knife and then soaking the wafers in water for at least several hours to lift the coating off the wafer. The resulting polyimide films allowed to dry and then subject to various property measurements. For example, a Hunter Lab spectrophotometer was used to measure b* and yellow index along with % transmittance (% T) over the wavelength range 350 nm-780 nm. Optical birefringence is measured with a Metricon instrument with a 543-nm laser. Optical Retardation is measured with an Axoscan instrument at 550 nm. Thermal measurements on films were made using a combination of thermogravimetric analysis and thermomechanical analysis as appropriate for the specific parameters reported herein. Mechanical properties were measured using equipment from Instron. Property measurements for these films are presented in Tables 2a and 2b.

TABLE 2a
Properties of Polyimide Films

| | | | | Compar- |
|---|---|---|---|---|
| | | | | ative |
| | | Example 4 | Example 5 | Example |
| Film | Composition | ODPA// | ODPA// | BPDA// |
| Properties | (mole %) | 3,3′DDS | Bis-P | Bis-P |
| | | 100//100 | 100//100 | 100//100 |
| | Cure | 260/AIR | 260/AIR | 260/N₂ |
| | Temp (° C.)/ | | | |
| | Atmosphere | | | |
| | Film | 9.87 | 10.31 | 10.20 |
| | Thickness | | | |
| | (μm) | | | |
| Thermal | T_{g} (° C.) | 251 | 259 | 278 |
| Properties | CTE | 43 | 63.14 | 56.13 |
| | (ppm/° C.) | | | |
| | 1.0% TGA WT | 453 | 471.58 | 470.65 |
| | LOSS (° C.) | | | |
| Mechan- | Tensile | 4.29 | | |
| ical | Modulus | | | |
| Properties | (GPa) | | | |
| | Tensile | 145.71 | | |
| | Strength | | | |
| | (MPa) | | | |
| | Elongation to | 5.18 | | |
| | Break (%) | | | |
| Optical | Yl | | 11.99 | 17.77 |
| Properties | b* | 7.28 | 6.83 | 11.01 |
| | R_{TH} at 550 nm | 20.19 | 14.14 | 36.25 |
| | (nm) | | | |

TABLE 2b
Properties of Polyimide Films

| | | Example 6 | Example 7 | Example 8 | Example 9 |
|---|---|---|---|---|---|
| Film | Composition | ODPA//Bis-P/ | ODPA/6FDA// | ODPA/6FDA// | ODPA/a-BPDA// |
| Properties | (mole %) | MPD | Bis-P | Bis-P/TFMB | Bis-P/TFMB |
| | | 100//90/10 | 90/10//100 | 90/10//90/10 | 60/40//90/10 |
| | Cure | 260/AIR | 260/AIR | 260/AIR | 260/AIR |
| | Temp (° C.)/ | | | | |
| | Atmosphere | | | | |
| | Film | 9.5 | 9.84 | 10.18 | 10.40 |
| | Thickness | | | | |
| | (μm) | | | | |
| Thermal | T_{g} (° C.) | 265 | 261 | 261 | 269 |
| Properties | CTE | 57.9 | 61.27 | 61.12 | 60.40 |
| | (ppm/° C.) | | | | |
| | 1.0% TGA WT | 468.1 | 476.5 | 480.37 | 473.69 |
| | LOSS (° C.) | | | | |
| Mechan- | Tensile | | 3.03 | 3.01 | 2.86 |
| ical | Modulus | | | | |
| Properties | (GPa) | | | | |
| | Tensile | | 112.12 | 101.95 | 103.12 |
| | Strength | | | | |
| | (MPa) | | | | |
| | Elongation to | | 9.37 | 13.28 | 5.57 |
| | Break (%) | | | | |
| Optical | Yl | 5.37 | 4.46 | 5.49 | 5.91 |
| Properties | b* | 3.54 | 2.65 | 3.19 | 3.45 |
| | R_{TH} at 550 nm | 15 | 13.7 | 19.5 | 15.8 |
| | (nm) | | | | |

Films of compositions disclosed herein are found to have Tg above 250° C. combined with low R_{TH} at 550 nm. The dianhydrnde component of Comparative Example 1 is relatively rigid, and the associated polyimide exhibits a significantly higher R_{TH} at 550 nm.

### Examples I-R—Preparation of Polyamic Acid Copolymers in NMP with Compositions

Example I: ODPA//3,3′DDS/TFMB 100/180120

Example J: ODPA//Bis-M/TFMB 100//50/50

Example K: ODPA///TFMB/Bis-P/APB-133 100//50/45/5

Example L: ODPA//Bis-P/TFMB/APB-133 100//60/30/10

Example M: ODPA/6FDA//Bis-P/TFMB/APB-133 90/10//60/30/10

Example N: ODPA/M1225//Bis-P/TFMB/APB-133 90/10//50/40/10

Example O: ODPA/M1225//Bis-PfTFMP 50/50//90/10

Example P: ODPA//TFMB/APB-133 1001/90/10

Example Q: ODPA//TFMB 100//100

Example R: ODPA//TFMB/Bis-P 1001180/20

Solutions containing polyamic acid of the above compositions were prepared in NMP in using analogous steps to those disclosed for Examples A and B above, except that specific dianhydrides and diamines, and their respective relative amounts, were appropriate for these target compositions. The prepared solutions were poured into a 2-liter HDPE bottles, tightly capped, and stored in a refrigerator for later use.

### Examples 10-19—Spin Coating and Imidization of Polyamic Acid Solutions with Compositions

Example 10: ODPA//3,3′DDS/TFMB 100//80/20

Example 11: ODPA//Bis-M/TFMB 100//50/50

Example 12: ODPA///TFMB/Bis-P/APB-133 100//50/45/5

Example 13: ODPA//Bis-P/TFMB/APB-133 100/160/30/10

Example 14: ODPA/6FDA/Bis-P/TFMB/APB-133 90/10//60/30/10

Example 15: ODPA/M1225//Bis-P/TFMB/APB-133 90/10//50/40/10

Example 16: ODPA/M1225//Bis-P/TFMP 50/50//90/10

Example 17: ODPA//TFMB/APB-133 100//90/10

Example 18: ODPA//TFMB 100//100

Example 19: ODPA//TFMB/Bis-P 100//80/20

In a manner analogous to that described above in Examples 1-3 and 4-9, the solution containing the polyamic acid copolymer prepared in Examples I-R were filtered, coated onto a 6″ silicon wafer, soft-baked, and imidized. Cure temperature of the imidization temperature profile in all cases did not exceed 260° C. and the process was run either under ambient atmospheric conditions or in a nitrogen gas atmosphere (see Table 3a, Table 3b, and Table 3c). The heating was then stopped and the temperature allowed to return slowly to ambient temperature (no external cooling). Afterward, the wafers were removed from the furnace and the coatings were removed from the wafers by scoring the coating around the edge of the wafer with a knife and then soaking the wafers in water for at least several hours to lift the coating off the wafer. The resulting polyimide films allowed to dry and then subject to various property measurements. For example, a Hunter Lab spectrophotometer was used to measure b* and yellow index along with % transmittance (% T) over the wavelength range 350 nm-780 nm. Optical birefringence is measured with a Metricon instrument with a 543-nm laser. Optical Retardation is measured with an Axoscan instrument at 550 nm. Thermal measurements on films were made using a combination of thermogravimetric analysis and thermomechanical analysis as appropriate for the specific parameters reported herein. Mechanical properties were measured using equipment from Instron. Property measurements for these films are presented in Tables 3a, 3b, and 3c.

TABLE 3a
Properties of Polyimide Films

| | | Example 10 | Example 11 | Example 12 |
|---|---|---|---|---|
| Film | Composition | ODPA//3,3′DDS/ | ODPA//Bis-M/ | ODPA//TFMB/ |
| Properties | (mole %) | TFMB | TFMB | Bis-P/APB-133 |
| | | 100//80/20 | 100//50/50 | 100//50/45/5 |
| | Cure | 260/AIR | 260/AIR | 260/AIR |
| | Temp (° C.)/ | | | |
| | Atmosphere | | | |
| | Film | 9.8 | 10.65 | 10.12 |
| | Thickness | | | |
| | (μm) | | | |
| Thermal | T_{g} (° C.) | 252 | 237 | 261 |
| Properties | CTE (ppm/° C.) | 48 | | 61.21 |
| | 1.0% TGA WT | 461 | 474.46 | 473.12 |
| | LOSS (° C.) | | | |
| Mechan- | Tensile | 4.48 | 3.38 | 3.05 |
| ical | Modulus | | | |
| Properties | (GPa) | | | |
| | Tensile | 152.48 | 97.65 | 110.29 |
| | Strength | | | |
| | (MPa) | | | |
| | Elongation to | 7.01 | 9.91 | 8.36 |
| | Break (%) | | | |
| Optical | Yl | | 4.59 | 5.16 |
| Properties | b* | 6.1 | 2.65 | 2.98 |
| | R_{TH} at 550 nm | 30.79 | 31.60 | 38.1 |
| | (nm) | | | |

TABLE 3b
Properties of Polyimide Films

| | | Example 13 | Example 14 | Example 15 | Example 16 |
|---|---|---|---|---|---|
| Film | Composition | ODPA//Bis-P/ | ODPA/SFDA// | ODPA/M1225// | ODPA/M1225// |
| Properties | (mole %) | TFMB/APB-133 | Bis-P/TFMB/ | Bis-P/TFMB/ | Bis-P/TFMB |
| | | 100//60/30/10 | APB-133 | APB-133 | 50/50//90/10 |
| | | | 90/10//60/30/10 | 90/10//50/40/10 | |
| | Cure | 260/AIR | 260/AIR | 260/AIR | 260/AIR |
| | Temp (° C.)/ | | | | |
| | Atmosphere | | | | |
| | Film | 9.98 | 9.80 | 9.92 | 10.09 |
| | Thickness | | | | |
| | (μm) | | | | |
| Thermal | Tg (° C.) | 252 | 254 | 261 | 250 |
| Properties | CTE (ppm/° C.) | 67.43 | 62.70 | 61.97 | 70.61 |
| | 1.0% TGA WT | 479.75 | 480.49 | 439.38 | 396.2 |
| | LOSS (° C.) | | | | |
| Mechan- | Tensile | | | | 3.07 |
| ical | Modulus | | | | |
| Properties | (GPa) | | | | |
| | Tensile | | | | 102.31 |
| | Strength | | | | |
| | (MPa) | | | | |
| | Elongation to | | | | 12.6 |
| | Break (%) | | | | |
| Optical | Yl | 4.80 | 4.70 | 5.10 | 6.99 |
| Properties | b* | 2.74 | 2.70 | 2.99 | 4.30 |
| | R_{TH} at 550 nm | 25.1 | 23.50 | 28.6 | 24.5 |
| | (nm) | | | | |

TABLE 3c
Properties of Polyimide Films

| | | Example 17 | Example 18 | Example 19 |
|---|---|---|---|---|
| Film | Composition | ODPA//TFMB/ | ODPA//TFMB | ODPA//TFMB/ |
| Properties | (mole %) | APB-133 | 100//100 | Bis-P |
| | | 100//90/10 | | 100//80/20 |
| | Cure | 260/AIR | 260/N₂ | 260/AIR |
| | Temp (° C.)/ | | | |
| | Atmosphere | | | |
| | Film | 10.39 | 9.13 | 10.54 |
| | Thickness | | | |
| | (μm) | | | |
| Thermal | Tg (° C.) | 270 | 269 | 273 |
| Properties | CTE (ppm/° C.) | 59.77 | 58.40 | 57.78 |
| | 1.0% TGA WT | 490.25 | 471.12 | 481.82 |
| | LOSS (° C.) | | | |
| Mechan- | Tensile | 3.84 | | 3.48 |
| ical | Modulus | | | |
| Properties | (GPa) | | | |
| | Tensile | 156.33 | | 128.57 |
| | Strength | | | |
| | (MPa) | | | |
| | Elongation to | 35.32 | | 36.29 |
| | Break (%) | | | |
| Optical | Yl | 3.04 | 9.76 | 4.50 |
| Properties | b* | 1.73 | 5.43 | 2.61 |
| | R_{TH} at 550 nm | 76.9 | 57.08 | 84.8 |
| | (nm) | | | |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. The use of numerical values in the various ranges specified herein is stated as approximations as though the minimum and maximum values within the stated ranges were both being preceded by the word “about.” In this manner, slight variations above and below the stated ranges can be used to achieve substantially the same results as values within the ranges. Also, the disclosure of these ranges is intended as a continuous range including every value between the minimum and maximum average values including fractional values that can result when some of components of one value are mixed with those of different value. Moreover, when broader and narrower ranges are disclosed, it is within the contemplation of this invention to match a minimum value from one range with a maximum value from another range and vice versa.

What is claimed is:

1. A polyimide film, wherein the polyimide film exhibits:
an in-plane coefficient of thermal expansion (CTE) that is less than 75 ppm/° C. between 50° C. and 250° C.;
a glass transition temperature (T_{g}) that is greater than 250° C. for the polyimide film cured at 260° C. in air;
a 1% TGA weight loss temperature that is greater than 450° C.;
a tensile modulus that is between 1.5 GPa and 5.0 GPa;
an elongation to break that is greater than 20%;
an optical retardation at 550 nm that is less than 100 nm for a 10-μm film;
a birefringence at 633 nm that is less than 0.002;
a haze that is less than 1.0%;
a b* that is less than 3;
a yellowness index that is less than 5; and
an average transmittance between 380 nm and 780 nm that is greater than 88%,
wherein the polyimide film is prepared from a solution composition comprising a polyamic acid comprising 4,4′-oxydiphthalic anhydride (ODPA) and 4,4′-[1,4-phenylenebis(1-methyl-ethylidene)] bisaniline (Bis-P).

2. The polyimide film of claim 1, wherein the solution composition comprises 4,4′-oxydiphthalic anhydride (ODPA), 4,4′-[1,4-phenylenebis(1-methyl-ethylidene)] bisaniline (Bis-P) and 2,2′-bis(trifluoromethyl) benzidine (TFMB).

3. The polyimide film of claim 2, wherein the mole % of ODPA//Bis-P//TFMB is 100/90/10.

4. The polyimide film of claim 1, wherein the polyimide film exhibits an optical retardation at 550 nm that is less than 20 nm for a 10-μm film.

5. A flexible replacement for glass in an electronic device wherein the flexible replacement for glass comprises a polyimide film according to claim 1.

6. An electronic device comprising the flexible replacement for glass according to claim 5.

7. The electronic device of claim 6 wherein the flexible replacement for glass is used in device components selected from the group consisting of device substrate, touch panel, cover film, and color filter.

8. A solution composition comprising a polyamic acid in a high boiling aprotic solvent, wherein the polyamic acid comprises 4,4′-oxydiphthalic anhydride (ODPA), and 4,4′-[1,4-phenylenebis(1-methyl-ethylidene)] bisaniline (Bis-P).

9. A solution composition comprising a polyamic acid in a high boiling aprotic solvent, wherein the polyamic acid comprises 4,4′-oxydiphthalic anhydride (ODPA), 4,4′-[1,4-phenylenebis(1-methyl-ethylidene)] bisaniline (Bis-P) and 2,2′-bis(trifluoromethyl) benzidine (TFMB).

10. The solution composition of claim 8, wherein the high-boiling aprotic solvent is N-methyl-2-Pyrrolidone (NMP).
